(19) United States
(12) Patent Application Publication
(10) Pub. No.: US 2024/0189884 A1
(43) Pub. Date: Jun. 13, 2024

(54) TUBE EXPANSION TOOL

(71) Applicant: MAKITA CORPORATION, Anjo-shi (JP)

(72) Inventor: Koichi YAKABE, Anjo-shi (JP)

(73) Assignee: MAKITA CORPORATION, Anjo-shi (JP)

(21) Appl. No.: 18/514,262

(22) Filed: Nov. 20, 2023

(30) Foreign Application Priority Data
Dec. 9, 2022 (JP) 2022-196795
Feb. 22, 2023 (JP) 2023-025925

(51) Int. Cl. B21D 39/20; B23Q 17/00

(52) U.S. Cl. CPC B21D 39/20; B23Q 17/005

(57) ABSTRACT

A tube expansion tool includes a female screw member that rotates by an electric motor. A screw shaft engages the female screw member to move in a front-rear direction. A front-end position sensor detects that the screw shaft has reached a front-end position. The screw shaft stops moving forward by a braking operation. A controller controls the braking operation of the electric motor. When the controller determines that the screw shaft has reached the front-end position based on a signal from the front-end sensor, the controller performs the braking operation. Also, when the controller detects that the screw shaft stops, the controller rotates the electric motor in a reverse direction to move the screw shaft rearward.

### CROSS-REFERENCE

This application claims priority to Japanese patent application serial number 2022-196795, filed on Dec. 9, 2022, and to Japanese patent application serial number 2023-025925, filed on Feb. 22, 2023, the contents of which are incorporated herein by reference in their entirety for all purposes.

### TECHNICAL FIELD

The present invention generally relates to a tube expansion tool that expands, for example, an end portion of a synthetic resin-made fluid pipe or an end portion of a copper-made fluid pipe (copper tube) for the fluid pipe to be coupled to a pipe fitting.

### BACKGROUND ART

For example, a fluid pipe made of PEX (cross-linked polyethylene) may be coupled to a metal/resin pipe fitting. For this purpose, a tube expansion tool has been used for expanding the inner diameter of an end portion of a PEX tubing. The end portion of the PEX tubing may be expanded by the tube expansion tool to allow the PEX tubing to be coupled to the fitting. The end portion of the PEX tubing may elastically and gradually recover around the fitting to form a tight connection. The PEX tubing may be firmly coupled to the fitting due to this elastic recovery.

A tube expansion tool that expands a PEX tubing may be driven by an electric motor. The tube expansion tool may include, for example, a screw shaft extending in a front-rear direction and an approximately conical wedge (mandrel) linked to a front portion of the screw shaft. The tube expansion tool may also include a plurality of jaws in front of the wedge. The plurality of jaws may be circumferentially arranged around the wedge. The plurality of jaws may be supported by a cap attached to the front portion of a main body housing of the tube expansion tool so as to be opened/closed in a radial direction of the screw shaft. The screw shaft may be prevented from rotating relative to the main body housing. The screw shaft may engage a female screw member that is supported by the main body housing so as to be rotatable around the screw shaft.

When the electric motor rotates the female screw member, the screw shaft may move in the front-rear direction. The jaws may be opened relatively to each other and radially outward of the wedge by being pushed by the wedge as the wedge moves forward together with the screw shaft. When the jaws are inserted into an opening of an end portion of the PEX tubing, for example, and opened radially outward, the end portion of the PEX tubing may expand. When the wedge moves rearward together with the screw shaft, the pushing force applied to the jaws may be released and the plurality of jaws may be closed radially inward.

After the screw shaft moves to a front-end position, the female screw member may be rotated in a reverse direction by the electric motor. Because of this movement, the screw shaft may move toward a rear-end position (return operation). It may be necessary to control the return operation of the screw shaft in an appropriate manner to efficiently expand the PEX tubing. However, methods for controlling the return operation have not been disclosed in the prior art in a concrete and detailed manner.

Furthermore, when the tube expansion tool has six jaws, an end portion of the PEX tubing may receive a force from the jaws at six places at circumferentially equal intervals to be expanded radially outward by a movement of the screw shaft in a front-rear direction. Because of this, the end portion of the PEX tubing may expand in an approximately hexagonal shape by a single expansion operation. The tube expansion tool may have a jaw rotation mechanism for rotating the jaws in a circumferential direction of the wedge to expand the end portion of the PEX tubing in nearly a cylindrical shape. In the jaw rotation mechanism, the plurality of jaws may be rotated by the electric motor at a specified rotation angle (for example, 15 degrees) in a predetermined direction (for example, a counterclockwise direction view from the front). The expansion operation of the jaws, which is performed by moving the screw shaft in the front-rear direction, and the rotation operation of the jaws by the jaw rotation mechanism, may be repeated alternately. Because of the operations, the position of each jaw that contacts an inner circumferential surface of the PEX tubing may successively move in a circumferential direction. Eventually, the end portion of the PEX tubing may expand equally to form an approximately cylindrical shape.

A PEX tubing can have several different sizes. For example, a 0.5-, 0.75-, 1-, or 1.5-inch nominal diameter may be generally used. As the size of the PEX tubing becomes larger, the force necessary to expand the end portion of the PEX tubing may become larger. Because of this, it may be desirable to use the jaws in accordance with the size of the PEX tubing. For example, a first cap includes the jaws, each of which has a first thickness in a radial direction, and a second cap includes the jaws, each of which has a second thickness in the radial direction, and either one of the first or second cap may be selected where the selected one attaches to the tube expansion tool. The first cap and the second cap may be detachably attached to a main body housing of the tube expansion tool by screw connection.

Rotation power may be transmitted from the jaw rotation mechanism to each jaw of the jaws owing to a projection/recess engagement provided in the jaw rotation mechanism and in the jaws. In more detail, the jaw rotation mechanism may include engaging projections, and each of the jaws may include engaging recesses. The engaging projections of the jaw rotation mechanism may engage the engaging recesses of the plurality of jaws, thereby transmitting the rotation power of the jaw rotation mechanism to the jaws. When the cap including the plurality of jaws is attached to the main body housing, it may happen that the engaging projections of the jaw rotation mechanism do not normally and mutually engage the jaws. For example, the cap attaches to the main body housing in a state that the engaging projections of the jaw rotation mechanism interfere with protrusions of the jaws in a front-rear direction. Therefore, the cap may not attach to a predetermined rear-end position of the main body housing. However, a user may erroneously recognize that the cap normally attaches to the predetermined rear-end position even though it is disposed of in front of the rear-end position.

When the user erroneously recognizes that the cap attaches to the predetermined rear-end position in a state, in which the engaging portions of the jaw rotation mechanism do not engage the engaging portions of the jaws in a normal manner, each of the jaws may not move to a predetermined position in a radial direction and rotate to a predetermined position in a circumferential direction. Eventually, the tube expansion tool may not function properly.

Thus, there is a need for a tube expansion tool to control a return operation of the screw shaft in an appropriate manner to efficiently expand the fluid pipe.

Furthermore, there is also a need for a tube expansion tool in which the cap comprising a plurality of jaws can be attached to a normal position of the main body housing in a constant manner.

### SUMMARY

According to one aspect of the present disclosure, a tube expansion tool for expanding an end portion of a fluid pipe comprises a female screw that is configured to be rotated by a motor. A screw shaft is configured to engage the female screw to move in a front-rear direction. A wedge is arranged at the front-end of the screw shaft, inserted into a plurality of jaws, and configured to expand the end portion of the fluid pipe via the plurality of jaws. A detector detects when the screw shaft has reached a front-end position. A controller performs a braking operation of the motor. When the controller determines that the screw shaft has reached the front-end position based on a signal from the detector, the controller performs the braking operation of the motor. Furthermore, when the controller detects that the screw shaft stops, the controller rotates the motor in a reverse direction to move the screw shaft rearward.

Because of this configuration, after the controller detects that the electric motor completely stops, the controller rotates the electric motor in the reverse direction. Accordingly, the controller can prevent the electric motor from rotating in the reverse direction while the electric motor is rotating in the forward direction. Thus, a large current, which flows when the electric motor is forcibly rotated in the reverse direction while rotating in the forward direction, can be prevented from flowing in the electric motor.

### BRIEF DESCRIPTION OF THE DRAWINGS

FIG. 1 is a perspective view of a tube expansion tool according to an exemplary embodiment of the present disclosure.

FIG. 2 is a perspective view of a tool main body of the tube expansion tool viewed from the front-right, from which a main body housing has been removed.

FIG. 3 is an exploded perspective view of the tool main body.

FIG. 4 is a perspective view of the tool main body of the tube expansion tool viewed from the rear-right, from which the main body housing has been removed.

FIG. 5 is a perspective view of the tool main body of the tube expansion tool viewed from the rear-left, from which the main body housing has been removed. This figure shows a state in which a screw shaft is at a rear-end position.

FIG. 6 is a perspective view of the tool main body of the tube expansion tool viewed from the rear-left, from which the main body housing has been removed. This figure shows a state in which the screw shaft is at a front-end position.

FIG. 7 is a lateral cross-sectional view of the tool main body viewed from the right, showing the state in which the screw shaft is at the rear-end position.

FIG. 8 is a lateral cross-sectional view of the tool main body viewed from the right, showing the state in which the screw shaft is at the front-end position.

FIG. 9 is a cross-sectional view taken along line IX-IX of FIG. 7.

FIG. 10 is a cross-sectional view taken along line X-X of FIG. 8.

FIG. 11 is a cross-sectional view taken along line XI-XI of FIG. 7.

FIG. 12 is a cross-sectional view taken along line XII-XII of FIG. 11.

FIG. 13 is a view similar to FIG. 12 showing a state in which the screw shaft is at the front-end position.

FIG. 14 is a top view of a rotation gear, a cam member and a plurality of jaws.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form to avoid obscuring significant aspects of the exemplary embodiments presented herein.

According to another aspect of the present disclosure, after the controller performs the braking operation, the controller rotates the motor in the reverse direction when the controller detects stopping or rearward movement of the screw shaft. Because of this configuration, even when the screw shaft moves rearward owing to an external force after a braking operation, the controller rotates the electric motor in the reverse direction. For example, the screw shaft quickly moves from a rearward direction to a forward direction, since the duration during which the screw shaft stops is very short. In this case, the controller cannot detect the stopping of the screw shaft and accordingly waits until the screw shaft completely stops. Even in this case, the controller can rotate the electric motor in the reverse direction when the screw shaft moves rearward owing to the external force. Because of this configuration, the screw shaft can move rearward in a short time.

According to another aspect of the present disclosure, after a predetermined duration has passed because the screw shaft reached the front-end position or the controller started to perform the braking operation, the controller rotates the motor in the reverse direction when the controller detects stopping or rearward movement of the screw shaft. Because of this configuration, more than the predetermined period-of-time (retention time) can be obtained during which an end portion of the fluid pipe can be expanded by moving the screw shaft forward. Thus, the end portion of the fluid pipe can be sufficiently expanded by one expansion operation, thereby reducing the number of expansion operations.

According to another aspect of the present disclosure, the predetermined period-of-time is set in a range of 0.1 seconds to 0.5 seconds. Because of this configuration, the fluid pipe can be efficiently expanded by obtaining the predetermined period-of-time (retention time).

According to another aspect of the present disclosure, the motor includes a stator and a rotor that rotates around the stator. The braking operation is configured such that the controller stops the supply of power to the motor, thereby suppressing the rotation of the rotor by an electromotive force because of inertial force of the rotor. Because of this configuration, little power is required for braking in comparison to a case where power is supplied to stop the electric motor. Also, the number of components can be reduced.

According to another aspect of the present disclosure, the detector includes a first magnet attached to the screw shaft and a first hall element attached to a tool main body of the tube expansion tool that detects the magnetism of the first magnet. Because of this configuration, the magnet, which does not require a wiring, is attached to the screw shaft that moves. In contrast, the front-end position sensor, which normally requires wiring, is attached to the tool main body, which does not move. Since wiring is arranged in the tool main body, the detector can be provided relatively easily. Also, the front-end position sensor, which is more expensive than the magnet, may be rarely damaged.

According to another aspect of the present disclosure, the tube expansion tool further comprises a first motor sensor that detects rotation of the motor. The controller determines that the screw shaft has reached the front-end position based on a signal from the first motor sensor. Because of this configuration for example, in a case where the motor sensor is already provided for other purposes, another sensor for judging the position of the screw shaft is not required. Accordingly, the number of components may not increase.

According to another aspect of the present disclosure, the tube expansion tool further comprises a second motor sensor that detects the rotation of the motor. The controller determines a stopping or rearward movement of the screw shaft based on a signal from the second motor sensor. Because of this configuration, the controller can detect a stopping or rearward movement of the screw shaft based on rotation of the electric motor.

According to another aspect of the present disclosure, the first motor sensor or the second motor sensor includes a second magnet attached to the motor and a second hall element which detects the magnetism of the second magnet. Because of this configuration, a relatively inexpensive element can be utilized for the motor sensor.

According to another aspect of the present disclosure, a transmission mechanism is between the motor and the screw shaft, and the transmission mechanism includes a gear that transmits an output of the motor. A sensor detects the movement of at least one of the motors, the transmission mechanism, and the screw shaft. The controller determines the stopping or rearward movement of the screw shaft based on a signal of the sensor. Because of this configuration, the controller can determine the stopping or rearward movement of the screw shaft by detecting movement of any one of the electric motor, the planetary gear reduction mechanism, the gear shaft, the idle gear, the female screw member, and the screw shaft.

According to another aspect of the present disclosure, a plurality of balls are placed in an engagement portion between the screw shaft and the female screw. Because of this configuration, a transmission efficiency of rotation power from the female screw member to the screw shaft can be improved by the plurality of balls inserted into the engagement portion. Accordingly, the rotation power of the female screw member can be converted to movement of the screw shaft in the front-rear direction in an efficient manner.

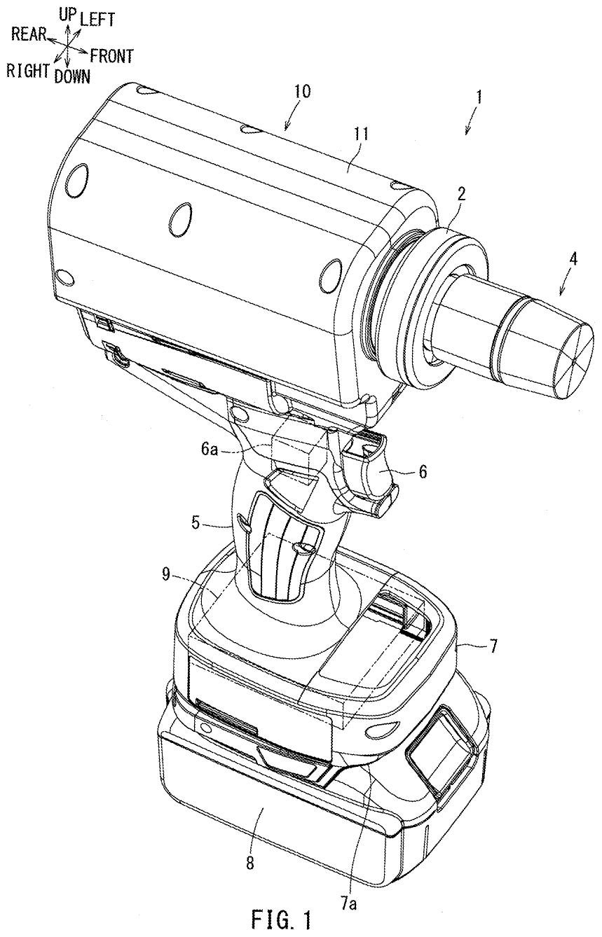

Next, an embodiment of the present disclosure will be described with reference to FIGS. 1 to 14. As shown in FIG. 1, a tube expansion tool 1 of the present disclosure may include a tool main body 10 that is housed in a main body housing 11. The tube expansion tool 1 may include a grip 5 in a lower portion of the main body housing 11. The grip 5 may extend downward. In FIG. 1, a user who holds the grip 5 of the tube expansion tool 1 may be situated on a rear side of the tube expansion tool 1. In the following explanation, the rear side of the tube expansion tool 1 may be also referred to as a user side, and a side opposite to the user side may be referred to as a front side. Also, a left/right side and an upper/lower side may be based on a user's position.

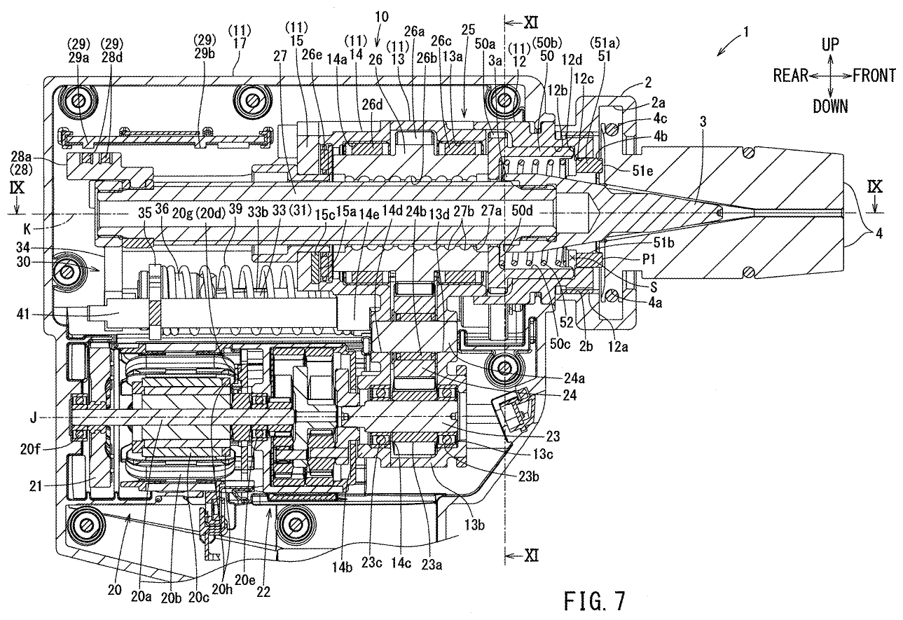

As shown in FIGS. 1, 7, and 12, a ring-shaped cap 2 may be attached to a front portion of the tool main body 10. As shown in FIG. 7, a cylindrical-shaped screw shaft 27 that extends in a front-rear direction may be arranged in the middle of the tool main body 10. An approximately conical wedge 3 may be attached to a front portion of the screw shaft 27. The wedge 3 may be positioned radially inside of the cap 2. The screw shaft 27 and the wedge 3 may be arranged along a screw shaft axis line K that extends in the front-rear direction in the middle of the tool main body 10. The screw shaft 27 and the wedge 3 may be movable along the screw shaft axis line K in the front-rear direction between a rear-end position and a front-end position. A plurality of jaws 4 may be arranged extending in the front-rear direction. The plurality of jaws 4 may be radially outward of the wedge 3 and radially inward of the cap 2. The plurality of jaws 4 may be arranged in a circumferential direction of the wedge 3 at equal intervals. The tube expansion tool 1 may include, for example, six jaws 4. The six jaws 4 may be arranged in the circumferential direction of the wedge 3 at an equal interval of 60 degrees. The plurality of jaws 4 may be opened/closed in a radial direction between a closed state and an open state. In the closed state, the plurality of jaws 4 may contact each other in the circumferential direction and cover the wedge 3. In the open state, the plurality of jaws 4 may be opened relative to each other radially outward and may expose a part of an end portion of the wedge 3.

As shown in FIG. 1, a trigger-type switch lever 6 may be arranged at a front surface of the grip 5. A user may pull the switch lever 6 while holding the grip 5. A switch main body 6a, which may turn on and off the tool 1 in conjunction with the pull operation of the switch lever 6, may be disposed within the grip 5. The switch main body 6a may be in an off-state when the switch lever 6 is not pulled and may be in an on-state when the switch lever 6 is pulled. When the user uses the tube expansion tool 1, the user may hold the grip 6 to insert the plurality of jaws 4 into, for example, an end portion of the synthetic resin-made PEX tubing. The plurality of jaws 4 may expand in the radial direction by pulling the switch lever 6. Because of this operation, the end portion of the PEX tubing may expand to a predetermined diameter. An approximately rectangular box-shaped housing 7 that extends in the front-rear direction and in a left-right direction with respect to the grip 5 may be disposed at a lower end of the grip 5. The housing 7 may house a controller 9. The controller 9 may include a shallow rectangular box-shaped case and a resin-encapsulated control board housed in the case. The controller 9 may be housed in the housing 7 such that a width thereof (the shortest side of the case) extends in the up-down direction. The controller 9 may mainly control driving of an electric motor 20, which will be discussed later in detail.

As shown in FIG. 1, a battery attachment portion 7a may be provided at a lower surface of the housing 7. A rectangular box-shaped battery 8 may be removably attached to the battery attachment portion 7a. The battery 8 may be removed from the battery attachment portion 7a by sliding the battery 8 in a forward direction with respect to the battery attachment portion 7a. In contrast, the battery 8 may be attached to the battery attachment portion 7a by sliding the battery in a rearward direction from the front-side of the battery attachment portion 7a. The battery 8 removed from the battery attachment portion 7a may be repeatedly recharged for use by a dedicated charger. The battery 8 may be used for other electric tools. The battery 8 may serve as a power source for the electric motor 20.

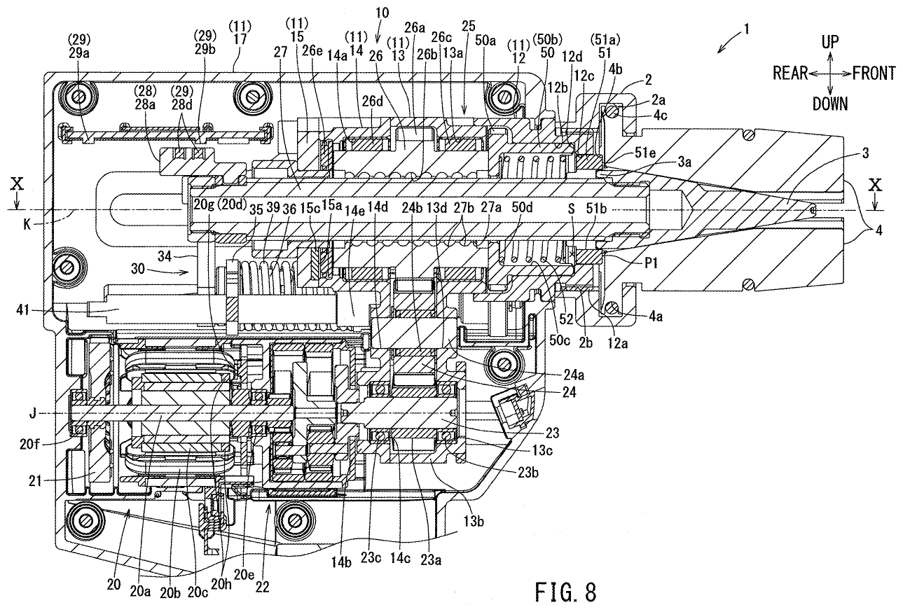

As shown in FIGS. 7 and 8, a main body housing 11 may include an outer case 17 that covers an outer periphery of the tool main body 10. A front side mechanism housing 12, a first center mechanism housing 13, a second center mechanism housing 14, and a rear side mechanism housing 15 may be assembled in the outer case 17. The front side mechanism housing 12, the first center mechanism housing 13, the second center mechanism housing 14, and the rear side mechanism housing 15 may be arranged in this order in the front-rear direction. The front side mechanism housing 12, the first center mechanism housing 13, the second center mechanism housing 14, and the rear side mechanism housing 15 may be respectively formed to have substantially a cylindrical shape having a hollow path at the center thereof that penetrates in the front-rear direction. The rear side mechanism housing 15 may be formed to have a plate shape having a hollow path in the same manner as the other housings. A thickness direction of the rear side mechanism housing 15 may be aligned in the front-rear direction. The front side mechanism housing 12, the first center mechanism housing 13, the second center mechanism housing 14, and the rear side mechanism housing 15 may cooperate to form a mechanism housing. The mechanism housing may house a gear shaft 23, an idle gear 24, and a female screw member 26, all of which will be discussed later in detail.

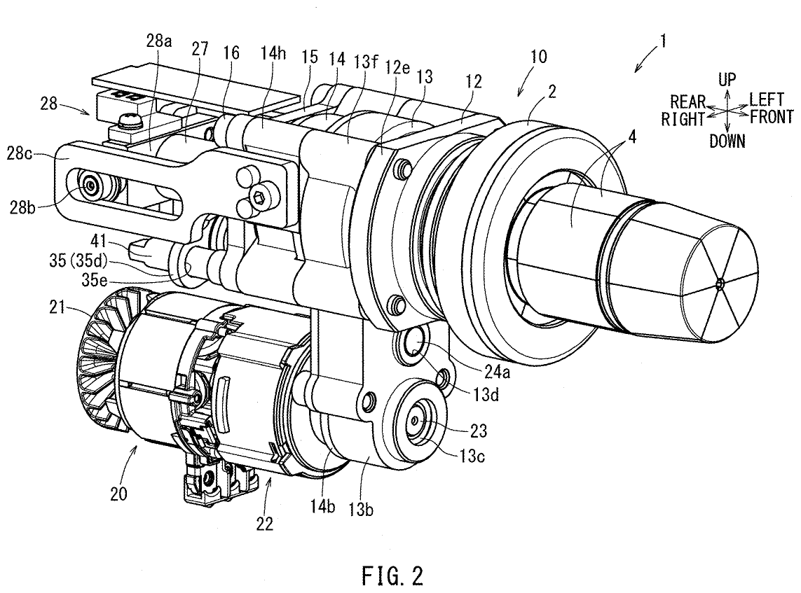

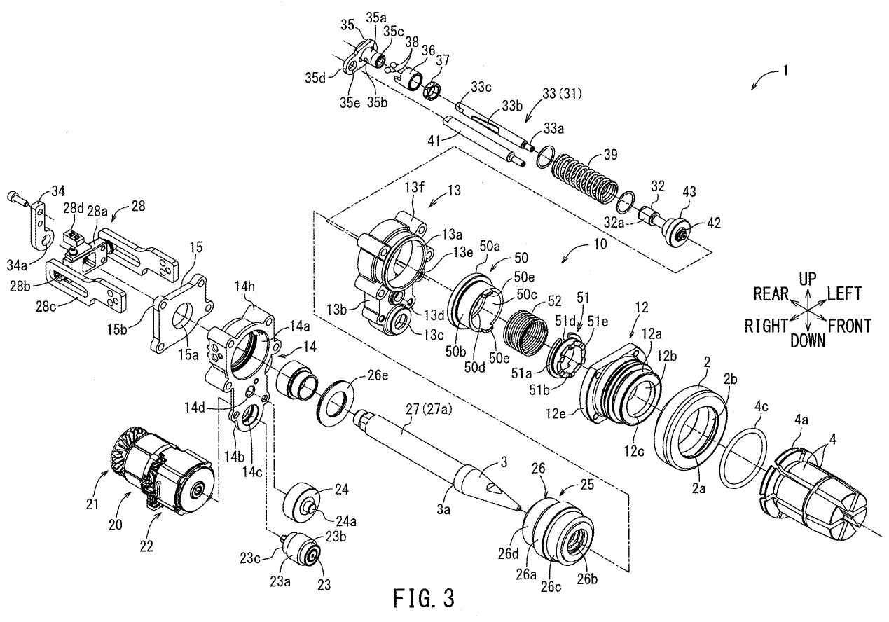

As shown in FIGS. 2 and 3, a male screw 12a may be formed on a front outer circumferential surface of the front side mechanism housing 12. A female screw 2b that engages the male screw 12a may be formed on an inner circumferential surface of the cap 2. By engaging the male screw 12a with the female screw 2b, the cap 2 may be coupled to a front portion of the front side mechanism housing 12.

As shown in FIGS. 2 and 3, the front side mechanism housing 12 may include an approximately rectangular-shaped flange 12e that extends radially outward on an outer peripheral surface of the front side mechanism housing 12. A screw hole that penetrates the flange 12e in the front-rear direction may be formed at each of the four corners of the flange 12e. The first center mechanism housing 13, the second center mechanism housing 14, and the rear side mechanism housing 15 may each include four boss portions 13f, 14h, and 15b, each of which is positioned radially outward. Each of the boss portions 13f, 14h, and 15b may form an approximate tubular shape extending in the front-rear direction and may include a through-hole that penetrates in the front-rear direction. By aligning the boss portions 13f, 14h, and 15b in the front-rear direction behind the flange 12e, the corresponding through-holes of the boss portions 13f, 14h, and 15b may communicate with the screw holes of the flange 12e in the front-rear direction. Four bolts may be inserted through the through-holes in the front-rear direction from the front side and be screw-connected to the screw holes of the flange 112e. Because of this configuration, the front side mechanism housing 12, the first center mechanism housing 13, the second center mechanism housing 14, and the rear side mechanism housing 15 may be linked in this order in the front-rear direction.

As shown in FIGS. 2 and 3, the first center mechanism housing 13 may include a tubular downward extension portion 13b that extends in a downward direction. The downward extension portion 13b may form an approximate U shape. Similarly, the second mechanism housing 14 may include a tubular downward extension portion 14b that extends in the downward direction and may form an approximate U shape. The downward extension portion 13b may be linked to the downward extension portion 14b, thereby forming a space in which a gear shaft 23 and an idle gear 24 are housed. The downward extension portion 13b may include two through-holes 13c, 13d that penetrate in the front-rear direction and are vertically arranged in parallel. The lower through-hole 13c, which is referred to as a recessed portion 13c, may support a gear shaft 23 that is discussed later. A shaft member 24a that supports the idle gear 24 may be press-fit to the upper through-hole 13d. The downward extension portion 14b may include two through-holes 14c, 14d that penetrate in the front-rear direction and are vertically arranged in parallel. The lower through hole 14c, which is referred to as a recessed portion 14c, may support the gear shaft 23. The shaft member 24a may be inserted into the upper through-hole 14d.

As shown in FIG. 7, an approximately tubular-shaped electric motor 20 may be housed in a rear lower portion of the outer case 17. The electric motor 20 may be, for example, a DC blushless motor. The electric motor 20 may be positioned above the grip 5 and below a screw shaft 27, which is located on a rear side of the outer case 17. A motor shaft 20a of the electric motor 20 may extend along a motor shaft axis line J in the front-rear direction, which is parallel to a screw shaft axis line K that passes through a center of the screw shaft 27. The motor shaft 20a may be supported by bearings 20e, 20f attached to the outer case 17 so as to be rotatable around the motor axis line J.

As shown in FIG. 7, the electric motor 20 may include a stator 20b that is unrotatably (statically) supported by the outer case 17. The stator 20b may be arranged radially outside of the motor shaft 20a. A rotor 20c of the electric motor 20 may be attached to the motor shaft 20a on an inner circumferential side of the stator 20b so as to be integrally rotatable with the motor shaft 20a. A motor sensor 20d may be disposed in front of the rotor 20c. The motor sensor 20d may be used to detect the number of rotations of the motor shaft 20a by detecting, for example, a rotation angle of the rotor 21c. The motor sensor 20d may include a magnet 20h attached to the rotor 20c and a hall element 20g that detects the magnetism of the magnet 20h. A fan 21 for introducing cool air to the electric motor 20 may be attached to the motor shaft 20a between the rotor 20c and the rear bearing 20f in the front-rear direction. When the fan 21 rotates integrally with the motor shaft 20a, cooling air may flow from the front side toward the rear side of the electric motor 20.

As shown in FIG. 7, a planetary gear reduction mechanism 22 for reducing an output speed of the motor shaft 20a may be positioned in front of the electric motor 20. The planetary gear reduction mechanism 22 may be housed in the outer case 17 along the front-rear direction. A rotation of the motor shaft 20a may be transmitted to the gear shaft 23 such that the rotation speed of the electric motor 20 is reduced at two stages by the planetary gear reduction mechanism 22.

As shown in FIG. 7, the gear shaft 23 may be supported by bearings 23b, 23c so as to be rotatable around the motor axis line J. The front bearing 23b may be press-fit to the recessed portion 13c of the first center mechanism housing 13. The rear bearing 23c may be press-fit to the recessed portion 14c of the second center mechanism housing 14. The gear shaft 23 may include a driving side gear 23a between the front bearing 23b and the rear bearing 23c. The driving side gear 23a may rotate around the motor axis line J integrally with the gear shaft 23.

As shown in FIG. 7, an idle gear 24 may be positioned between the gear shaft 23 and the screw shaft 27 in the up-down direction. The idle gear 24 may be supported by the shaft member 24a, which is formed in a cylindrical shape and extends in the front-rear direction, so as to be rotatable around an axis of the shaft member 24a. The idle gear 24 may engage the driving side gear 23a of the gear shaft 23 that is positioned below the idle gear 24. The idle gear 24 may also engage a driven side gear 26a that is discussed later.

As shown in FIG. 7, the tool main body 10 may include a feed screw mechanism 25, which may be also referred to as a ball screw mechanism. The feed screw mechanism 25 may include the screw shaft 27 and a female screw member 26. A male screw 27a may be formed on an outer circumferential surface of the screw shaft 27. The female screw member 26 may form an approximate cylindrical shape and cover the screw shaft 27 in a circumferential direction. A female screw 26b may be formed on an inner circumferential surface of the female screw member 26. The female screw 26b of the female screw member 26 may engage the male screw 27a of the screw shaft 27 via a plurality of balls 27b. The driven side gear 26a, which extends radially outward and engages the idle gear 24, may be formed on an outer circumferential surface of the female screw member 26. A rotation of the gear shaft 23 may be transmitted to the female screw member 26 due to the engagement of the driving side gear 23a with the idle gear 24 and the engagement of the idle gear 24 with the driven side gear 26a.

As shown in FIG. 7, the female screw member 26 may be rotatably supported around the screw shaft axis line K by bearings 26c, 26d that are housed in the tool main body 10. The front bearing 26c may be press-fit to an inner circumferential surface 13a of the first center mechanism housing 13. The rear bearing 26d may be press-fit to an inner circumferential surface 14a of the second center mechanism housing 14. A thrust bearing 26e for receiving a thrust load that pushes the female screw member 26 in a rearward direction may be arranged between a rear surface of the female screw member 26 and a front surface 15a of the rear side mechanism housing 15.

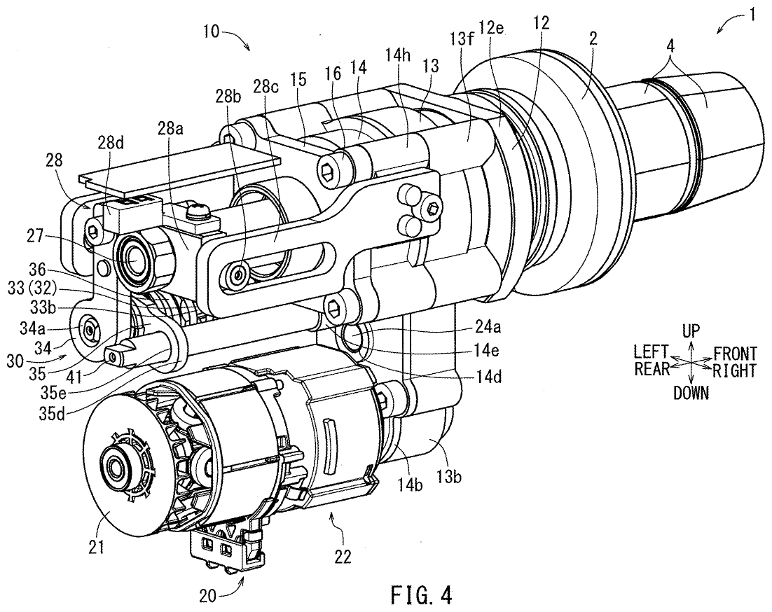

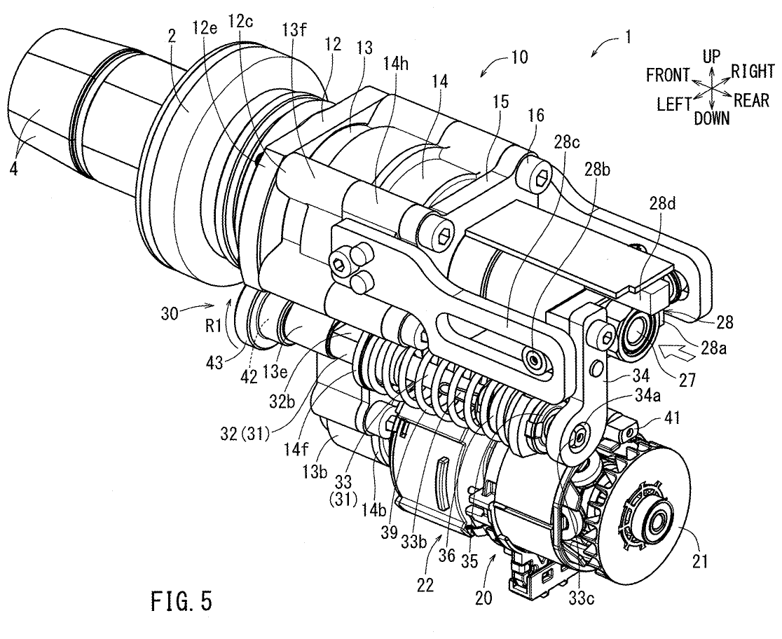

As shown in FIGS. 4 and 5, a screw shaft guide 28 may be positioned at a rear portion of the screw shaft 27. The screw shaft guide 28 may guide a movement of the screw shaft 28 in the front-rear direction. Also, the screw shaft guide 28 may stop rotation of the screw shaft 28. The screw shaft guide 28 may include a roller shaft 28a that is coupled to an end portion of the screw shaft 27 and that extends in a left-right direction. Though not clearly shown in the figures, the end portion of the screw shaft 27 may be inserted into an opening of the roller shaft 28a such that the screw shaft 28 does not rotate around the screw shaft axis line K. A roller 28b may be provided on both left and right ends of the roller shaft 28a. A pair of rails 28c that are each formed in a loop shape and extends in the front-end direction may be provided on both left and right sides of the second center mechanism housing 14. The roller 28b may engage the pair of the rails 28c so as to move in the front-rear direction along the pair of rails 28c. The screw shaft 27 may be moved integrally with the roller shaft 28a in the front-rear direction while being guided by the roller 28b.

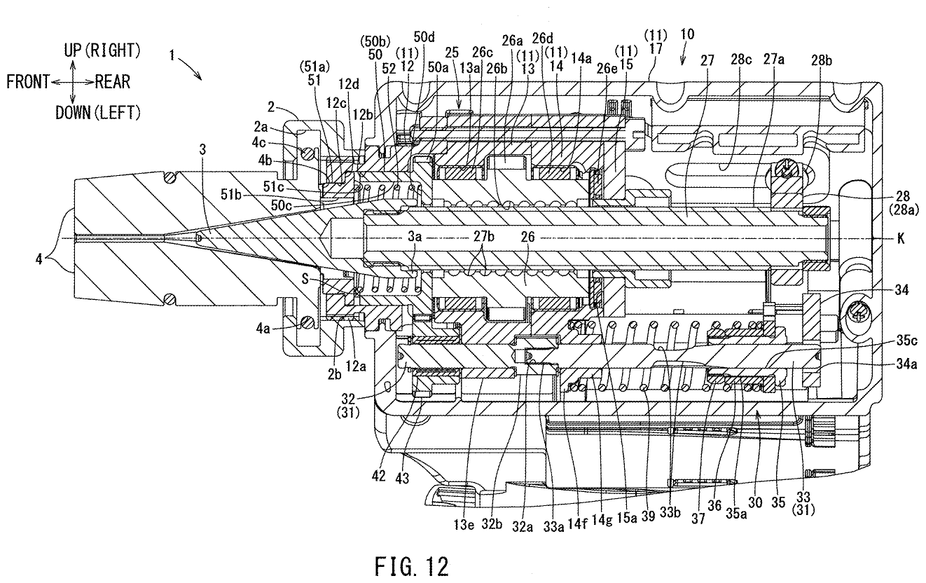

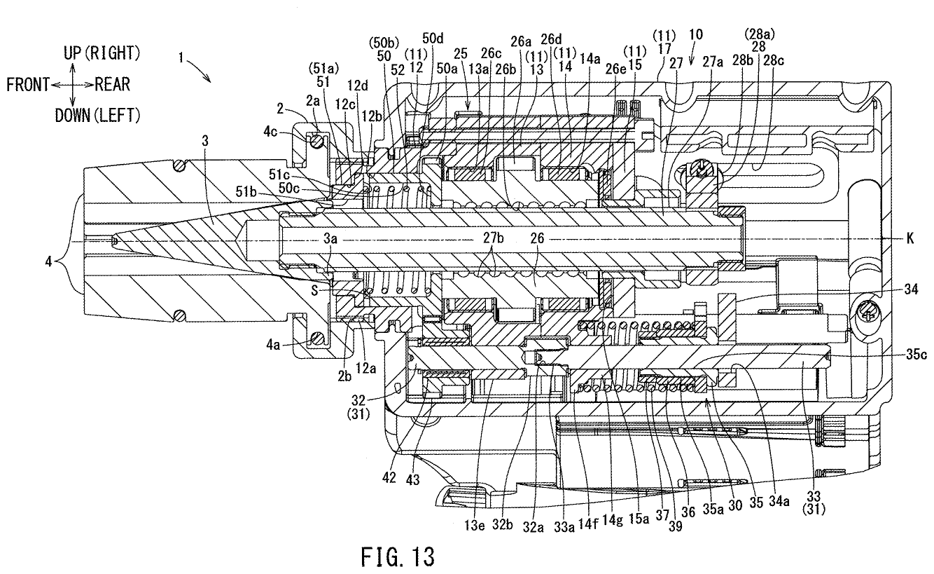

As shown in FIGS. 5, 6, 12, and 13, the tool main body 10 may include a jaw rotation mechanism 30 that rotates the plurality of jaws 4. As shown in FIGS. 12 and 13, the plurality of jaws 4 may rotate around the screw shaft axis line K by the jaw rotation mechanism 30. The jaw rotation mechanism 30 may include a push plate 34 that moves in the front-rear direction in interlocking with rotation of the motor shaft 20a. A shaft 31 may rotate around an axis of the shaft 31 in interlocking with the movement of the push plate 34 in the front-rear direction.

As shown in FIGS. 3, 4, and 12, the jaw rotation mechanism 30 may include a ball retainer 35 that is attached to the shaft 31. The ball retainer 35 may be movable in the front-rear direction along an extending direction of the shaft 31. A guide shaft 41 extending in parallel with the shaft 31 may be positioned on the right side of the shaft 31. A tubular guide shaft support portion 14e that extends in the rearward direction may be arranged in the downward extension portion 14b of the second center mechanism housing 14. A male screw provided at an end portion of the guide shaft 41 may engage a female screw of the guide shaft support portion 14e, thereby fixing the guide shaft 41 to the second center mechanism housing 14.

As shown in FIG. 3, the ball retainer 35 may include an approximately cylindrical-shaped sleeve attachment portion 35a and a lateral extension portion 35d. The lateral extension portion 35d may extend in a rightward direction of the sleeve attachment portion 35a. A shaft insertion hole 35c that penetrates in the front-rear direction may be formed at the center of the sleeve attachment portion 35a. The shaft 31 may be inserted by sliding into the shaft insertion hole 35c in the front-rear direction. A through-hole 35e that penetrates in the front-rear direction may be formed in the lateral extension portion 35d. The guide shaft 41 may be inserted by sliding into the through hole 35e in the front-rear direction. Because of this configuration, the ball retainer 35 may be slid in the front-rear direction while being guided by the shaft 31 and the guide shaft 41. Also, the ball retainer 35 may be prevented from rotating around the shaft 31.

As shown in FIGS. 4-6, the push plate 34 may be formed in a plate shape. The push plate 34 may be integrally attached to the roller shaft 28a such that a plate thickness direction is the front-rear direction. The push plate 34 may extend downward below the roller shaft 28a. Also, the push plate 34 may be arranged behind the sleeve attachment portion 35a (refer to FIG. 3). The push plate 34 may include a through hole 34a that penetrates in the front-rear direction. The shaft 31 extending rearward behind the sleeve attachment portion 35a may pass through the through-hole 34a. The push plate 34 may move in the front-rear direction integrally with the screw shaft 27. When the screw shaft 27 moves forward, the push plate 34 may press the rear surface of the ball retainer 35 in the forward direction. When the screw shaft 27 moves rearward, the push plate 34 may move to be apart from the ball retainer 35. Accordingly, the push plate 34 may not produce a force to move the ball retainer 35.

As shown in FIG. 3, the sleeve attachment portion 35a may include a pair of ball retention holes 35b that penetrate in the left-rear direction and that communicate with the shaft insertion hole 35c. A ball 38 may be inserted into each of a pair of ball retention holes 35b. The pair of balls 38 and a sleeve 36 that covers the ball retention holes 35b from radially outside may be mounted to the sleeve attachment portion 35a. By mounting the sleeve 36 to the sleeve attachment portion 35a, the pair of balls 38 may be unreleasably (statically) retained in the ball retention holes 35b. The pair of balls 38 may be disposed on the left and right side of the shaft 31. The pair of balls 38 may be prevented from rotating around the shaft 31 due to the static ball retainer 35 that is prevented from rotation. A nut 37 for retaining the sleeve 36 may be attached to a front portion of the sleeve attachment portion 35a.

As shown in FIGS. 3, 12, and 13, a front shaft 32 may be attached to a rear shaft 33 in the front-rear direction to form the shaft 31. The front shaft 32 may be supported by a shaft supporting portion 13e of the first center mechanism housing 13 to be rotatable around an axis of the front shaft 32. The rear shaft 33 may be supported by a shaft supporting portion 14g of the second center mechanism housing 14 to be rotatable around an axis of the rear shaft 33. The rear shaft 33 may be inserted into the ball retainer 35. A male screw 33a may be formed in a front portion of the rear shaft 33. A female screw 32a that engages the male screw 33a of the rear shaft 33 may be formed in a rear portion of the front shaft 32. By screw-connecting the female screw 32a of the front shaft 32 to the male screw 33a of the rear shaft 33, the front shaft 32 may be integrally connected to the rear shaft 33.

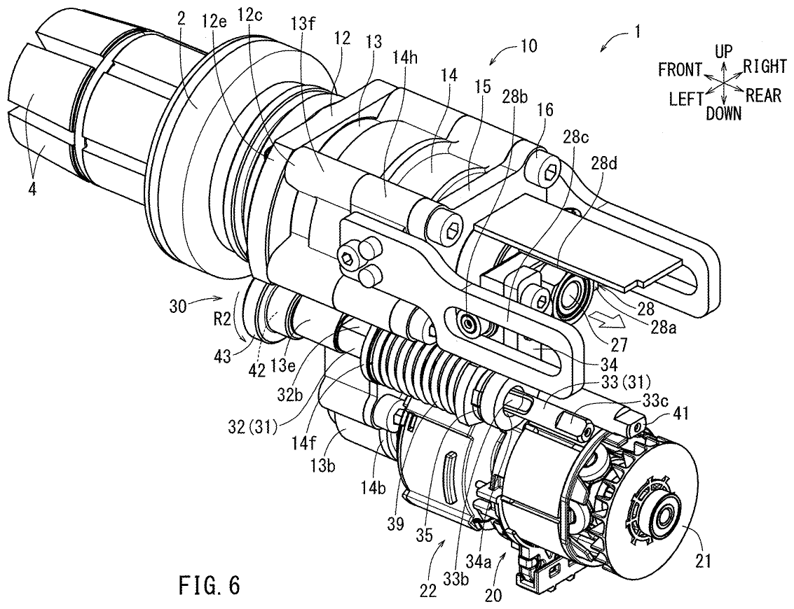

As shown in FIGS. 3, 12, and 13, a pair of ball grooves 33b may be formed on an outer circumferential surface of the rear shaft 33. Each of the pair of ball grooves 33b may extend in a longitudinal direction of the rear shaft 33. Also, each of the pair of ball grooves 33b may extend on a circumferential direction from rear to front like a screw groove. Referring to FIG. 6, each of the ball grooves 33b may extend from rear to front in a direction indicated by an arrow R2 (a second rotation direction). The pair of ball grooves 33b may be arranged in a positional relationship of point symmetry with respect to an axis center of the rear shaft 33. Each of the pair of balls 38, which is disposed radially inside from the ball retention hole 35b, may engage one of the corresponding ball grooves 33b.

As shown in FIGS. 5 and 6, when the ball retainer 35 moves in the front-rear direction with respect to the rear shaft 33, the pair of balls 38 (refer to FIG. 3) may move in the ball grooves 33b along the extension direction of the ball grooves 33b. The pair of balls 38 may not rotate around the rear shaft 33, and thus the rear shaft 33 may rotate around the axis of the rear shaft 33 with respect to the ball retainer 35 that moves in the front-rear direction. Referring to FIG. 5, when the ball retainer 35 moves in the forward direction, the rear shaft 33 may rotate in a direction indicated by an arrow R1 (a first rotation direction) with respect to the ball retainer 35. On the other hand, when the ball retainer 35 moves in the rearward direction, the rear shaft 33 may rotate in a direction indicated by the arrow R2 with respect to the ball retainer 35. The front shaft 32 that is screw-connected to the rear shaft 33 may rotate integrally with the rear shaft 33 around an axis of the front shaft 32.

As shown in FIGS. 12 and 13, a flange-shaped spring receiving portion 14f that extends radially outside may be formed in the shaft supporting portion 14g of the second center mechanism housing 14. A compression spring 39 that biases the ball retainer 35 in the rearward direction may be inserted between the spring receiving portion 14f and the ball retainer 35.

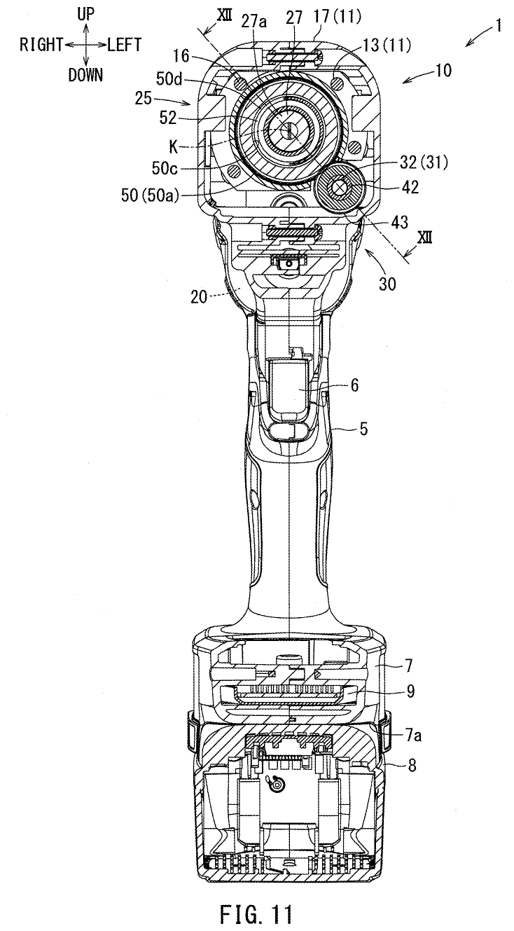

As shown in FIGS. 11-13, the jaw rotation mechanism 30 may include a cylindrical-shaped one-way clutch 42 and a driving side gear 43. The one-way clutch 42 and the driving side gear 43 may be attached to a front portion of the front shaft 32 in front of the shaft supporting portion 13e. The one-way clutch 42 may be disposed between the front shaft and the driving side gear 43 in a radial direction of the front shaft 32. The one-way clutch 42 may permit only one-way rotation of the front shaft 32 on an inner circumferential side to an outer circumferential side in the radial direction of the front shaft 32. The one-way clutch 42 may be, for example, a sprag clutch. The one-way clutch 42 may transmit rotation of the front shaft 32 in the second rotation direction R2 (refer to FIG. 6) to the driving side gear 43. On the other hand, the one-way clutch 42 may not transmit rotation of the front shaft 32 in the first rotation direction R1 (refer to FIG. 5) to the driving side gear 43. Accordingly, the front gear 32 may idle.

As shown in FIGS. 5 and 6, flat portions 32b in the width direction may be formed in a rear portion of the front shaft 32. The flat portions 32b may include a pair of surfaces that extend in the front-rear direction in parallel with each other. The flat portions 32b may be arranged between the first center mechanism housing 13 and the second center mechanism housing 14 in the front-rear housing. Also, the flat portions 32b may be positioned to be exposed outside of the first and second mechanism housing 13, 14. Similar to the flat portions 32b, flat portions 33c in the width direction may be formed in a rear-end portion of the rear shaft 33. The flat portions 33c may include a pair of surfaces that extend in the front-rear direction in parallel with each other. A user may screw-connect the rear shaft 33 to the front shaft 32 by rotating the rear shaft 33 while holding the flat portions 33c of the rear shaft 33 by use of, for example, a wrench, while preventing rotation of the front shaft 32 with holding the flat portions 32b of the front shaft 32 by use of, for example, another wrench.

As shown in FIGS. 3, 9, and 10, the jaw rotation mechanism 30 may include an approximately cylindrical-shaped rotation gear 50 and an approximately cylindrical-shaped cam member 51. The rotation gear 50 may be positioned in front of the female screw member 26. The cam member 51 may be positioned in front of the rotation gear 50. The rotation gear 50 and the cam member 51 may be supported on an inner circumferential surface of the front side mechanism housing 12 to be coaxially rotatable around the screw shaft axis line K. The front side mechanism housing 12 may include a first inner circumferential surface 12b and a second inner circumferential surface 12c, both of which are centered at the screw shaft axis line K. The first and second inner circumferential surfaces 12b, 12c may be arranged adjacent and communicate with each other. The second inner circumferential surface 12c may be disposed in front of the first inner circumferential surface 12b. The second inner circumferential surface 12c may have a diameter smaller than the first inner circumferential surface 12b. A front-end of the first inner circumferential surface 12b may be linked to a rear-end of the second circumferential surface 12c by an extension surface 12d that extends in a radial direction.

As shown in FIGS. 3, 12, and 13, the rotation gear 50 may include a cylindrical-shaped cylindrical wall 50b and a driven side gear 50a that extends radially outward from a rear portion of the cylindrical wall 50. The cylindrical wall 50b may include a through hole 50c in the center of the cylindrical wall 50b which penetrates in the front-rear direction. The insertion hole 50c may have a diameter such that the screw shaft 27 and the wedge 3 are inserted into the insertion hole 50c and movable in the front-rear direction. An outer circumferential surface of the cylindrical wall 50b may slide with the first inner circumferential surface 12b of the front side mechanism housing 12, thereby rotating the cylindrical wall 50b around the screw shaft axis line K. The driven side gear 50a may be screwed with the driving side gear 43 behind the first inner circumferential surface 12b. Rotation power of the driving side gear 43 may be reduced and transmitted to the driven side gear 50a. When the driving side gear 43 rotates in the second rotation direction R2 (refer to FIG. 6), the driven side gear 50a may rotate counterclockwise viewed from the front. On the contrary, when the driving side gear 43 rotates in the first rotation direction R1 (refer to FIG. 5), the driven side gear 50a may rotate clockwise viewed from the front.

As shown in FIGS. 12 and 13, the rotation gear 50 may include a spring receiving portion 50d that extends radially inward from a rear portion of the cylindrical wall 50b. The spring receiving portion 50d may be disposed radially inward of the driven side gear 50a. An inner circumferential surface of the spring receiving portion 50d may be sized to pass through the screw shaft 27 and not to pass through a rear-end 3a of the wedge 3. A rear portion of a coil spring 52 may contact a front surface of the spring receiving portion 50d. The coil spring 52 may be discussed later. The spring receiving portion 50d may serve as a stopper for preventing the screw shaft 27 from excessively moving in the rearward direction. When the screw shaft 27 moves rearward, the rear-end 3a of the wedge 3 may be disposed in front of the spring receiving portion 50d. When the rear-end 3a of the wedge 3 contacts the front surface of the spring receiving portion 50d, the screw shaft 27 cannot move further in the rearward direction.

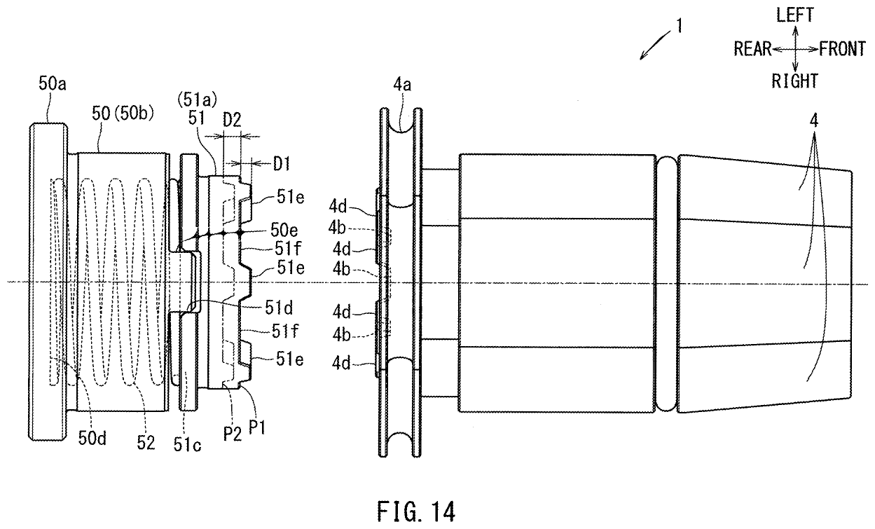

As shown in FIGS. 3 and 14, the rotation gear 50 may include an approximately rectangular-shaped guide 50e that protrudes frontward from a front surface of the cylindrical wall 50b. The guide 50e may be formed in a circumferential direction of the cylindrical wall 50b at an interval of 180 degrees. Thus, two guides 50e may be formed in the cylindrical wall 50b. Each guide 50e may guide the cam member 51 such that the cam member 51 does not rotate relatively with respect to the rotation gear 50 and is movable in the front-rear direction.

As shown in FIGS. 3, 12-14, the cam member 51 may include a cylindrical-shaped cylindrical portion 51a. An outer circumferential surface of the cylindrical portion 51a may slide with the second inner circumferential surface 12c of the front side mechanism housing 12, thereby rotating the cylindrical portion 51a around the screw shaft axis line K. The cylindrical portion 51a may include a through hole 51b in the center of the cylindrical portion 51a which penetrates in the front-rear direction. The through hole 51b may have a diameter such that the screw shaft 27 and the wedge 3 can be inserted into the through hole 51b. The cylindrical portion 51a may include a second spring receiving portion 51c that protrudes radially outward in a flange-shape at a rear portion of the cylindrical portion 51a. An outer circumferential surface of the second spring receiving portion 51c may have approximately the same diameter as the outer circumferential surface of the cylindrical wall 50b of the rotation gear 50. An outer circumferential surface of the second spring receiving portion 51c may slide with the first inner circumferential surface 12b of the front side mechanism housing 12, thereby rotating the second spring receiving portion 51c around the screw shaft axis line K. A coil spring (a biasing member) 52 may be inserted between the spring receiving portion 50d of the rotation gear 50 and the second spring receiving portion 51c of the cam member 51. The cam member 51 may be biased by the coil spring 52 in the forward direction relating to the rotation gear 50. A biasing direction in which the cam member 51 receives a biasing force by the coil spring 52 may be a direction in which the screw shaft axis line K extends.

As shown in FIGS. 3 and 14, the second spring receiving portion 51c may include a guide engagement portion 51d that is cut radially inward in a cutout shape and passes through the second spring receiving portion 51c in the front-rear direction. The guide engagement portion 51d may be formed in a circumferential direction of the second spring receiving portion 51c at an interval of 180 degrees. Each of the guide engagement portions 51d may engage a corresponding guide 50e of the rotation gear 50. The cam member 51 may rotate integrally with the rotation gear 50 around the screw shaft axis line K (refer to FIG. 12) by engagement of the guide engagement portions 51d with the guides 50e. Also, the cam member 51 may be movable relative to the rotation gear 50 in the front-rear direction by engagement of the guide engagement portions 51d with the guides 50c.

As shown in FIGS. 12-14, when the cam member 51 is disposed at a front position P1, the coil spring 52 may have approximately a natural length. When the cam member 51 is disposed at the front position P1, there may be formed a space S that allows the cam member 51 to move rearward between the cylindrical wall 50b and second spring receiving portion 51c. The length of the guides 50e in the front-rear direction and the length of the guide engagement portions 51d in the front-rear direction may be made such that when the cam member 51 is disposed at the front position P1, the guides 50e may not disengage from the guide engagement portions 51d.

As shown in FIGS. 3 and 14, the cam member 51 may include a plurality of cam engagement portions 51e, each of which extends forward from a front surface 51f of the cylindrical portion 51a. The cam engagement portions 51e may be formed in a rectangular shape. Each of the cam engagement portion 51e may be formed in a circumferential direction of the cylindrical portion 51a at an interval of 60 degrees. Thus, there may be six cam engagement portions 51e in total. The length D1 of the cam engagement portion 51e in the front-rear direction may be made to be equal to or less than D2, which is a distance by which the cam member 51 is movable relative to the rotation gear 50 from the front position P1 to a rear position P2 (retraction position). In other words, the distance D2 may be equal to or greater than the length D1 that is the length of the cam engagement portion 51e in the front-rear direction. FIG. 14 shows that a positional relationship between the guides 50e and the guide engagement portion 51d are clearly shown when the cam member 51 is at the position P1. However, an actual front position P1 may be set such that the cam member 51 moves forward to a position immediately before the guides 50e disengages from the guide engagement portions 51d.

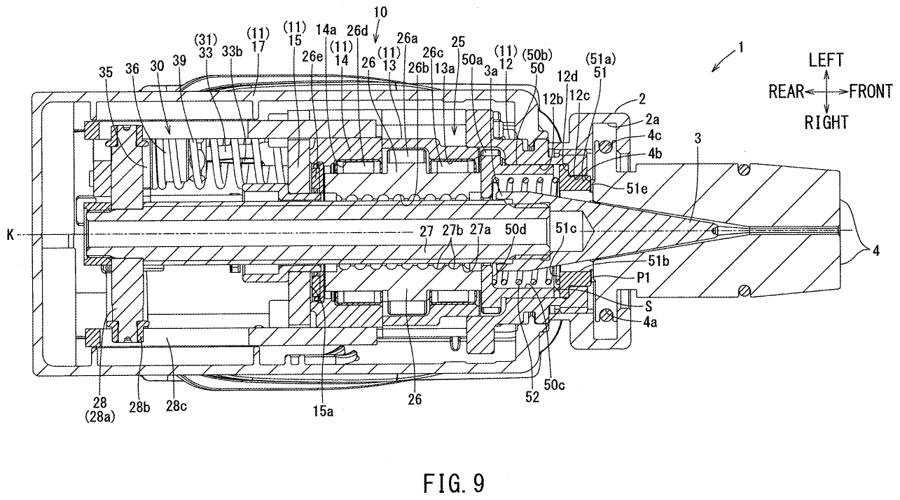

As shown in FIGS. 9, 10, and 14, a jaw engagement portion 4b may be formed in a recessed shape on a rear surface of each of the plurality of jaws 4. Each of the plurality of jaw engagement portions 4b may engage one of the plurality of cam engagement portions 51e of the cam member 51. The plurality of jaws 4 may rotate integrally with the cam member 51 around the screw shaft axis line K by engagement of the cam engagement portions 51e with the jaw engagement portions 4b of the jaw 4. A plurality of projections 4d extending rearward relating to the jaw engagement portions 4b may be formed at both ends of each of the jaw engagement portions 4b in a circumferential direction thereof. A length between the jaw engagement portion 4b and the projection 4d in the front-rear direction may be approximately equal to the length D1 of the cam engagement portion 51e.

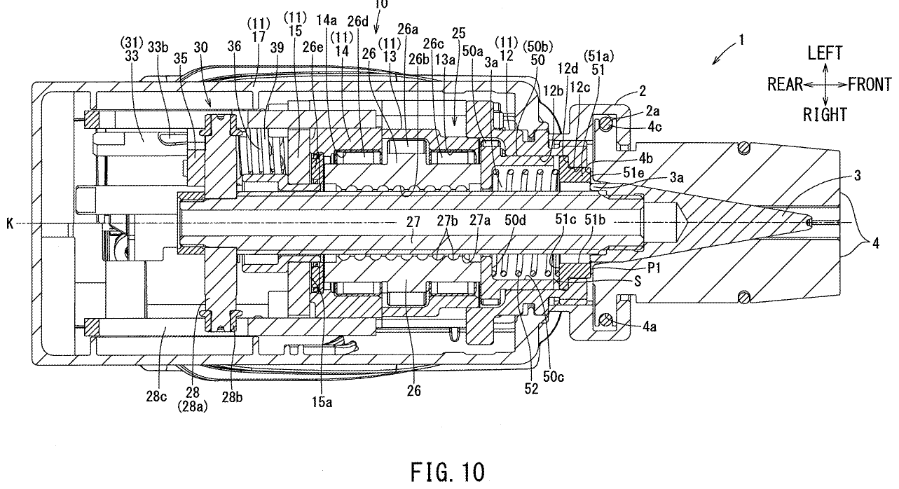

As shown in FIGS. 9 and 10, each jaw 4 may include a ring housing groove 4a in an arcuate shape in cross-section on a radially outer circumferential surface of the rear portion of each jaw 4. Each ring housing groove 4a of the jaw 4 may be continued to each other in a circumferential direction to form an annular groove. The plurality of jaws 4 may be linked to each other in the circumferential direction by a ring 4c that is elastically extensible and inserted into the ring housing grove 4a. The cap 2 may include a jaw-supporting groove 2a that houses the ring 4c in an inner circumferential surface of the cap 2. The jaw supporting groove 2a may extend radially outward in a circumferential direction. The jaw supporting groove 2a may allow the ring 4c to move in a radial direction and may prevent the ring 4c from moving in the front-rear direction. The plurality of jaws 4 may open/close radially with respect to the ring 4c that is supported by the ring housing groove 4a.

As shown in FIGS. 7 and 8, a detector 29 may include a magnet 28d, a rear-end position sensor 29a, and a front-end position sensor 29b. The rear-end position sensor 29a and the front-end position sensor 29b may detect magnetism of the magnet 28d. The magnet 28d may be attached to an upper portion of the roller shaft 28a. The rear-end position sensor 29a and the front-end position sensor 29b may be mounted on an upper inner circumferential surface of the outer case 17. A rear-end position of the screw shaft 27 may be detected by the rear-end position sensor 29a. A front-end position of the screw shaft 27 may be detected by the front-end position sensor 29b. The rear-end position sensor 29a may be positioned above the magnet 28d when the screw shaft 27 moves to the rear-end position. The rear-end position sensor 29a may detect magnetism of the magnet 28d and transmit a signal to a controller 9 when the screw shaft 27 moves to the rear-end position. The front-end position sensor 29b may be positioned above the magnet 28d when the screw shaft 27 moves to the front-end position. The front-end position sensor 29b may detect magnetism of the magnet 28d and transmit a signal to the controller 9 when the screw shaft 27 moves to the front-end position. The rear-end position sensor 29a and the front-end position sensor 29b may be, for example, hall elements. When two magnets 28d are mounted on the roller shaft 28a, as shown in FIG. 14, the rear-end position sensor 29a can detect both two magnets 28d. Accordingly, the rear-end position may be decided by the controller 9 based on which one of the magnets 28d is detected. Similarly, the front-end position may be decided by the controller 9 based on which one of the magnets 28d is detected. Accordingly, a movement range of the screw shaft 27 may be adjusted.

Referring to FIGS. 7 to 13, the feed screw mechanism 25 and the jaw rotation mechanism 30 will be explained. When the motor shaft 20a of the electric motor 20 rotates, a rotation speed of the motor shaft 20a may be reduced by the planetary gear reduction mechanism 22 to transmit to the gear shaft 23. When the gear shaft 23 rotates, the idle gear 24 that engages the driving side gear 23a may rotates. The driven side gear 26a of the female screw member 26 may engage the idle gear 24 to rotate the female screw member 26 around the screw shaft axis line K. When the female screw member 26 rotates, the screw shaft 27 that is prevented from rotation by the screw shaft guide 28 may move in the front-rear direction. When the screw shaft 27 moves forward, the wedge 3 that is attached to the end portion of the screw shaft 27 may push both the plurality of jaws 4 and the ring 4c to open radially outward. On the contrary, when the screw shaft 27 moves rearward, the ring 4c may shrink to close the plurality of jaws 4 radially inward.

The following may be one example of a method for controlling a return operation of the screw shaft 27. Referring to FIGS. 1, 7, and 8, the controller 9 may switch between a forward rotation and a reverse rotation of the motor shaft 20a of the electric motor 20. The screw shaft 27 may move forward when the electric motor 20 rotates in the forward direction. On the contrary, the screw shaft 27 may move rearward when the electric motor 20 rotates in the reverse direction. When a user releases a pull operation of the switch lever 6, the electric motor 20 may rotate in the reverse direction. Because of this, the screw shaft 27 may be normally disposed at the rear-end position. When the controller 9 receives a signal from the rear-end position sensor 29a, the controller 9 may detects that the screw shaft 27 is disposed at the rear-end position. When the user pulls the switch lever 6, the controller 9 may rotate the electric motor 20 in the forward direction. Accordingly, the screw shaft 27 may move forward. When the screw shaft 27 moves to the front-end position, the front-end position sensor 29b may transmit a signal to the controller 9. The controller 9 may determine that the screw shaft 27 has reached the front-end position based on the signal from the front-end position sensor 29b.

When the controller 9 determines that the screw shaft 27 has reached the front-end position, the controller 9 may stop supplying power to the electric motor 20. However, after the supply of power is stopped by the controller 9, the rotor 20c of the electric motor 20 may rotate by an inertial force of the rotor 20c. Because of this, an induction current may be generated in a coil of the stator 20b by electromagnetic induction. By electromagnetic induction, a magnetic force that attracts the magnet 20h of the rotor 20c may be generated in the stator 20b. Because of this, the rotation of the rotor 20c may be suppressed (which is referred to as regenerative braking). Rotation of the rotor 20c may be stopped by a brake action caused by the counter electromotive force. The controller 9 may detect that the rotation of the electric motor 20 is stopped based on a signal from the motor sensor 20d. In other words, the controller 9 may detect that the movement of the screw shaft 27 is stopped based on the signal from the motor sensor 20d. When the controller 9 determines that the rotation of the electric motor 20 is completely stopped, the controller 9 may rotate the electric motor 20 in the reverse direction. Accordingly, the screw shaft 27 may move rearward. When the screw shaft 27 moves to the rear-end position, the rear-end position sensor 29a may transmit a signal to the controller 9. When the controller 9 receives the signal, the controller 9 may determine that the screw shaft 27 has reached to the rear-end position (initial position). Then, the controller 9 may stop supplying power to the electric motor 20.

The following may be another method for controlling the return operation of the screw shaft 27. After the controller 9 stops supplying power to the electric motor 20, the controller 9 may rotate the electric motor 20 in the reverse direction when the controller detects that the screw shaft 27 moves rearward. As described above, when the screw shaft 27 moves forward, the plurality of jaws 4 may expand an end portion of the PEX tubing. During this time, the plurality of jaws 4 may receive a contraction force from the PEX tubing. Accordingly, the screw shaft 27 may receive a force in a direction to move rearward owing to this contraction force. In some cases, the screw shaft 27 that has reached the front-end position may start to move rearward by the contraction force of the PEX tubing without being in a standstill state (without a stopping time). In this case, the controller 9 cannot detect that the screw shaft 27 stops moving. The controller 9 that is discussed in the previous embodiment may be configured to move the screw shaft 27 rearward when the screw shaft 27 stops, for example, for more than a predetermined period of time. Thus, when the screw shaft 27 moves rearward and then stops owing to a balancing between the contraction force of the PEX tubing and rotation torque of the electric motor 20, the controller 9 may move the screw shaft 27 further rearward. Because of this, it may take an extra time before the controller 9 starts to rotate the electric motor 20 in the reverse direction. In a preferred embodiment, the electric motor 20 may rotate the electric motor 20 in the reverse direction when the controller 9 detects that the screw shaft 27 moves rearward. Because of this configuration, the screw shaft 27 may move rearward in a shorter time than in the previous example, since the controller 9 does not need to detect that the screw shaft 27 completely stops. It can be presumed that the controller 9 detects that the screw shaft 27 stops or the screw shaft 27 moves rearward based on a signal from the front-end position sensor 29b.

The following may be further another method for controlling the return operation of the screw shaft 27. The controller 9 may detect stopping or rearward movement of the screw shaft 27 after a predetermined period-of-time (for example, 0.3 seconds) has passed since the screw shaft 27 reached the front-end position or the controller 9 stopped supplying power to the electric motor 20. Because of this, more than the predetermined period-of-time may be obtained during which the screw shaft 27 expands the plurality of jaws radially outward to expand the end portion of the PEX tubing. Accordingly, the end portion of the PEX tubing may be expanded in a sufficient manner by one expansion operation, thereby reducing the number of times of the expansion operations.

The controller 9 may determine that the screw shaft 27 has reached the front-end position based on a signal from the motor sensor 20d. Furthermore, the controller 9 may detect stopping or movement of the screw shaft 27 based on a signal from the motor sensor 20d.

The following may be further another method for controlling the return operation of the screw shaft 27. The controller 9 may include a sensor that detects movement of any one of the electric motor 20, the planetary gear reduction mechanism 22, the gear shaft 23, the idle gear 24, the female screw member 26, and the screw shaft 27. For example, as shown in FIG. 7, a pressure sensor 15c may be placed on a front surface 15c of the rear side mechanism housing 15. When the screw shaft 27 moves rearward owing to a contraction force of the PEX tubing, the female screw member 26 may sometimes move rearward a little together with the screw shaft 27. In this case, the controller 9 may detect a rearward movement of the female screw member 26 by the pressure sensor 15c which detects a pressure force applied to the rear side mechanism housing 15 from the female screw member 26. The controller 9 may detect stopping or movement of the screw shaft 27 based on a signal from the pressure sensor 15c.

As described above, as shown in FIG. 3, the tube expansion tool 1 may include the female screw member 26 that is rotated by the electric motor 20. The screw shaft 27 may move in the front-rear direction by engagement of the female member 26 with the screw shaft 27. The wedge 3 may be attached to a front portion of the screw shaft 27. The wedge 3 may be inserted to between the plurality of jaws 4 such that an end portion of a fluid pipe is expanded via the plurality of jaws 4. The front-end position sensor 29b may detect that the screw shaft 27 has reached the front-end position. The controller 9 may control braking of the electric motor 20. When the controller 9 determines that the screw shaft 27 has reached the front-end position based on the signal from the front-end position sensor 29d, the controller 9 may operate braking of the electric motor 20. Further, when the controller 9 detects that the screw shaft 27 stops, the controller 9 may rotate the electric motor 20 in the reverse direction to move the screw shaft 27 rearward.

Because of this configuration, after the controller 9 detects that the electric motor 20 completely stops, the controller 9 may rotate the electric motor 20 in the reverse direction. Accordingly, the controller 9 may prevent the electric motor 20 from rotating in the reverse direction while the electric motor 20 is rotating in the forward direction. Thus, a large current, which flows when the electric motor 20 is forcibly rotated in the reverse direction while rotating in the forward direction, can be prevented from flowing in the electric motor 20.

After the controller 9 operates braking of the electric motor 20, the controller 9 may rotate the electric motor 20 in the reverse direction when detecting stopping or rearward movement of the screw shaft 27. Because of this configuration, even when the screw shaft 27 moves rearward owing to, for example, an external force, after a braking operation, the controller 9 may rotate the electric motor 20 in the reverse direction. For example, there may be a case where the screw shaft 27 quickly moves from a rearward direction to a forward direction. In other words, a period-of-time during which the screw shaft 27 stops may be very short. In this case, the controller 9 cannot detect stopping of the screw shaft 27 and accordingly the controller 9 may wait until the screw shaft 27 completely stops. Even in this case, the controller 9 may rotate the electric motor 20 in the reverse direction when the screw shaft 27 moves rearward owing to the external force. Because of this configuration, the screw shaft 27 can move rearward in a short time.

When a predetermined period-of-time has passed since the screw shaft 27 reached the front-end position or braking operation started (the controller 9 stopped supplying power to the electric motor 20), the controller 9 may determine stopping or rearward movement of the screw shaft 27. Because of this configuration, more than the predetermined period-of-time (retention time) may be obtained during which an end portion of the fluid pipe can be expanded by moving the screw shaft 27 forward. Thus, the end portion of the fluid pipe can be sufficiently expanded by one expansion operation, thereby reducing the number of expansion operations.

The above predetermined period-of-time may be set in a range of 0.1 seconds to 0.5 seconds. Because of this configuration, the fluid pipe can be efficiently expanded by obtaining the predetermined period-of-time (retention time).

As shown in FIG. 7, the electric motor 20 may include a stator 20b and a rotor 20c that rotates around the stator 20b. The braking of the electric motor 20 may be performed by the controller 9. In more detail, braking of the electric motor 20 may be made such that the controller 9 stops supply of power to the electric motor 20 and then rotation of the rotor 20c is suppressed by an electromotive force caused by an inertial force of the rotor 20c. Because of this configuration, little power may be required for braking in comparison with a case where power is supplied to stop the electric motor 20. Also, the number of components can be reduced.

As shown in FIG. 7, the detector 29 may include a magnet 28d (a first magnet) that is attached to the screw shaft 27. The detector 29 may also include the front-end position sensor 29b (a first hall element) that is attached to the tool main body 10 and detects magnetism of the magnet 28d. Because of this configuration, the magnet 28d, which does not require a wiring, may be attached to the screw shaft 27 that moves. In contrast, the front-end position sensor 29b, which normally requires wiring, may be attached to the tool main body 10 that does not move. Wiring may be arranged in the tool main body 10, and thus the detector 29 may be provided relatively easily. Also, the front-end position sensor 29, which is more expensive than the magnet 28d, may be rarely damaged.

As shown in FIG. 7, the expansion tool 1 may include a motor sensor 20d that detects rotation (number of rotations) of the electric motor 20. The controller 9 may determine that the screw shaft 27 reaches a front-end position of the screw shaft 27 based on a signal from the motor sensor 20d. Because of this configuration, in a case where, for example, the motor sensor 20d is already provided by other purposes, another sensor for judging a position of the screw shaft 27 may not be newly required. Thus, the number of components may not be increased.

As shown in FIG. 7, the motor sensor 20d detects the number of rotations performed by the electric motor 20. The controller 9 may detect that the screw shaft 27 stops or moves rearward based on a detection signal from the motor sensor 20d. Because of this configuration, the controller 9 can detect stopping or rearward movement of the screw shaft 27 based on rotation of the electric motor 20.

According to FIG. 7, the motor sensor 20d may include a magnet 20h (second magnet) attached to the electric motor 20 and a hall element 20g (second hall element) that detects magnetism of the magnet 20h. Because of this configuration, a relatively unexpensive element may be utilized for the motor sensor 20d.

As shown in FIG. 7, the planetary gear reduction mechanism 22 including gears for transmitting output of the electric motor 20, the gear shaft 23, the idle gear 24, and the female screw member 26 may be arranged between the electric motor 20 and the screw shaft 27. The pressure sensor 15c may detect movement of any one of the electric motor 20, the planetary gear reduction mechanism 22, the gear shaft 23, the idle gear 24, the female screw member 26, and the screw shaft 27. The controller 9 may determine the stopping or rearward movement of the screw shaft 27 based on a signal from the pressure sensor 15c. Because of this configuration, the controller 9 may determine stopping or rearward movement of the screw shaft 27 by detecting movement of any one of the electric motor 20, the planetary gear reduction mechanism 22, the gear shaft 23, the idle gear 24, the female screw member 26, and the screw shaft 27.

As shown in FIGS. 7-10, a plurality of balls 27b may be inserted into an engagement portion of the screw shaft 27 with the female screw member 26. Because of this configuration a transmission efficiency of rotation power from the female screw member 26 to the screw shaft 27 may be improved by the plurality of balls 27b inserted into the engagement portion. Accordingly, rotation power of the female screw member 26 can be converted to movement of the screw shaft 27 in the front-rear direction in an efficient manner.

The embodiments discussed above may be modified in various ways. In the exemplified embodiment, braking of the electric motor 20 may be performed owing to the counter electromotive force generated by the inertia force of the rotor 20c. Instead of this configuration, the controller 9 may supply power to the electric motor 20 to stop the rotor 20c.

The predetermined period-of-time (retention time) may be an arbitrary time selected within a range of 0.1 seconds to 0.5 seconds. The controller 9 may start to count the retention time from a time when the screw shaft has reached the front-end position.

In the exemplified embodiment, the controller 9 may detect stopping or rearward movement of the screw shaft 27 based on a signal from the front-end position sensor 29b, the motor sensor 20d, or the pressure sensor 15c. Instead, the controller 9 may detect stopping or rearward movement of the screw shaft 27 based on more than one signals selected from the front-end position sensor 29b, the motor sensor 20d, and the pressure sensor 15c.

The pressure sensor 15c may be placed at any position if the pressure sensor 15c can detect movement of any one of the electric motor 20, transmission mechanisms, and the screw shaft 27. Furthermore, in FIGS. 7-8, the magnet 28d may be positioned at two positions. Instead, the magnet 28d may be positioned at one position or more than two positions. Furthermore, in FIGS. 7-8, the detector 29 may include the rear-end position sensor 29a and the front-end position sensor 29b (two hall elements). Instead, the detector 29 may include only one hall element. In this case, by placing the magnet 28d at a plurality of positions, the screw shaft 27 at the front and end positions can be detected.

Next, with reference to FIGS. 1-14, a tube expansion tool 1 will be explained in which the cap 2 with a plurality of jaws 4 can be attached to a normal position of the main body housing 11 in a constant manner. As shown in FIGS. 2-4, when the screw shaft 27 moves forward, the push plate 34 that is attached to the roller shaft 28a may move forward integrally with the screw shaft 27. The push plate 34 may push the ball retainer 35 forward against a biasing force of the compression spring 39. When the ball retainer 35 moves forward, the ball 38 may engage the ball groove 33b (refer to FIG. 3) and the shaft 31 may rotate in the first rotation direction R1 (refer to FIG. 5) since the guide shaft 41 prevents rotation of the ball retainer 35. At this time, one-way clutch 42 may not transmit rotation power of the shaft 31 to the driving side gear 43. The rotation gear 50 may not rotate since rotation power of the shaft 31 is not transmitted to the driving side gear 43. Because of this configuration, the plurality of jaws 4 and the cam member 51 that engages the rotation gear 50 may not rotate. Accordingly, without rotating around the screw shaft axis line K, the plurality of jaws 4 may be pushed by the wedge 3 to open radially outward.

When the screw shaft 27 moves forward, the cam member 51 may not receive a rotation force from the rotation gear 50. Also, the cam member 51 may not receive a movement force in the front-rear direction from the screw shaft 27. Because of this configuration, the cam member 51 may be held at a front position P1 (refer to FIG. 14) where the coil spring 52 has approximately a natural length. The coil spring 52 with approximately a natural length may not store compression energy.

When the screw shaft 27 moves rearward, the push plate 34 that is attached to the roller shaft 28a may move rearward integrally with the push plate 34. A pressing force of the push plate 34 toward the ball retainer 35 may be released and the ball retainer 35 may move rearward by receiving a biasing force of the compression spring 39. When the ball retainer 35 moves rearward, the shaft 31 may rotate in the second rotation direction R2 (refer to FIG. 6) because the ball 38 engages the ball groove 33b and the guide shaft 41 prevents rotation of the ball retainer 35. At this time, one-way clutch 42 may transmit rotation power of the front shaft 32 to the driving side gear 43. The rotation gear 50 may rotate counterclockwise viewed from the front because the rotation power of the driving side gear is transmitted to the rotation gear 50. The cam member 51 and the plurality of jaws 4 may rotate integrally with the rotation gear 50. Accordingly, the plurality of jaws 4 may close radially inward while rotating around the screw shaft axis line K in a counterclockwise direction viewed from the front.

When the screw shaft 27 moves rearward, the cam member 51 may receive a rotation force in a circumferential direction from the rotation gear 50. However, the cam member 51 may not receive a movement force in the front-rear direction from the rotation gear 50. Because of this configuration, the cam member 51 may be held at the front position P1 where the coil spring 52 has approximately a natural length. Accordingly, the coil spring 52 with approximately the natural length may not store compression energy.

Referring to FIGS. 1 and 14, a different kind of jaws 4, each kind of which has a different thickness in a radial direction, can be removably attached to the tube expansion tool 1. When the cap 2 holding the plurality of jaws 4 is detached from the main body housing 11, the jaw engagement portion 4b of each of the plurality of jaws 4 may disengage from a corresponding cam engagement portion 51e of the cam member 51. When the cap 2 that holds a different kind of the plurality of jaws 4 is newly attached to the main body housing 11, a jaw engagement portion 4b of each of the different kind of the plurality of jaws 4 may engage one of the cam engagement portions 51e of the cam member 51. At this time, it may sometimes happen that the jaw engagement portion 4b does not engage the cam engagement portion 51e in a normal state. For example, it may sometimes happen that a projection 4d adjacent to the jaw engagement portion 4b may contact one of the cam-receiving portions 51e in the front-rear direction. In this case, each of the plurality of jaws 4 may be positioned forward from a normal position by approximately a length D1 in the front-rear direction. Because of this configuration, the cap 2 may not be attached to the main body housing 11 in a sufficient manner. In this state, rotation power of the cam member 51 may not be transmitted to each of the plurality of jaws 4 in a sufficient and satisfactory manner.

In the preferred embodiment of the jaw rotation mechanism 30, the cam member 51 may be biased by the coil spring 52 toward the front position P1. Furthermore, the cam member 51 may move from the front position P1 to the retraction position P2. In other words, the cam member 51 may move the distance D2, which is larger than the distance D1, in the front-rear direction. Because of this configuration, when the projection 4d contacts the cam engagement portion 51e in the front-rear direction such that the projection 4d and the cam engagement portion 51e interfere to each other, the interference between the projections 4d and the cam engagement portion 51e may be released by a rearward movement of the cam engagement portion 51e by the distance D2. Accordingly, the jaw engagement portion 4b may newly engage the cam engagement portion 51e in a normal state.

As described above, the tube expansion tool 1 that expands an end portion of the fluid pipe made of a synthetic resin or made of copper may include a screw shaft 27 that extends in the front-rear direction in the main body housing 11 as shown in FIGS. 7 and 9. The tube expansion tool 1 may include a female screw member 26 that engages the screw shaft 27 to rotate around the screw shaft 27, thereby moving the screw shaft 27 in the front-rear direction. The tube expansion tool 1 may include a plurality of jaws 4 that are pushed by the wedge 3 attached to a front portion of the screw shaft 27 such that the plurality of jaws 4 open radially outward to each other. The tube expansion tool 1 may include a cap 2 that supports the plurality of jaws 4 so as to radially open/close and that is removably attached to the main body housing 11. The tube expansion tool 1 may include a cam member 51 that is movable in the front-rear direction and that engages a rear surface of the plurality of jaws 4 such that the cam member 51 is rotatable around an axis of the screw shaft 27 integrally with the plurality of jaws 4. Also, the tube expansion tool 1 may include a coil spring (biasing member) 52 that biases the cam member 51 in the forward direction.

Because of this configuration, when the cap 2 including the plurality of jaws 4 is attached to the main body housing 11, the cam member 51 may be movable in the rearward direction. Accordingly, an interference between the cam member 51 and a rear surface of the plurality of jaws 4 in the front-rear direction can be prevented. Thus, the cap 2 may not be held forward from a rearmost position relating to the main body housing 11, and the cap 2 may be easily positioned at the rearmost position. After the cap 2 is attached to the rearmost position, the cam member 51 may be rotated around the axis of the screw shaft 27 relatively with respect to the plurality of jaws 4 such that the cam member 51 that is biased forward may engage the rear surface of the plurality of jaws 4 in a normal state. Accordingly, rotation power of the cam member 51 can be efficiently transmitted to the plurality of jaws 4.

As shown in FIGS. 7 and 9, the tube expansion tool 1 may include a rotation gear 50 that engages the cam member 51 such that the cam member 51 rotates around the axis of the screw shaft 27 integrally with the plurality of jaws 4. Because of this configuration, when the cam member 51 engages the rear surface of the plurality of jaws 4 in a normal state, rotation power of the rotation gear 50 may be efficiently transmitted to the plurality of jaws 4 via the cam member 51 by biasing the cam member 51 in the forward direction. When the cam member 51 does not engage the plurality of jaws 4 in a normal state, the cam member 51 may be moved rearward against the biasing force of the coil spring 52 such that engagement of the cam member 51 with the rear surface of the plurality of jaws 4 returns to a normal state.

As shown in FIGS. 7 and 9, the rotation gear 50 may include a cylindrical-shaped cylindrical wall 50b, into which the screw shaft 27 and the wedge 3 are inserted. The rotation gear 50 may include a spring receiving portion 50d that extends radially inward from the cylindrical wall 50b. The cam member 51 that is formed in a cylindrical shape may be arranged coaxially with the rotation gear 50 such that the screw shaft 27 and the wedge 3 can be inserted into the cam member 51. The biasing member 52 may be a coil spring that is inserted between the rotation gear 50 and the cam member 51. The coil spring 52 may be arranged on an inner circumferential side of the rotation gear 50, and a rear portion of the coil spring 52 may contact the spring receiving portion 50d. Because of this configuration, the coil spring 52 may be housed radially inward of the cylindrical wall 50b of the rotation gear 50 in a compact manner. Thus, an outer circumferential region of the rotation gear 50 and an outer circumferential region of the cam member 51 may be made compact. Eventually, the tube expansion tool 1 can be made compact, thereby improving operability of the tube expansion tool 1 which is used for expanding an end portion of the PEX tubing arranged at a narrow arca. The cam member 51 may be biased forward by an approximately equal force in circumferential direction. Accordingly, the cam member 51 may be prevented from leaning relating to the screw shaft 27. Thus, the cam member 51 may move smoothly in the front-rear direction.

As shown in FIGS. 7 and 9, the main body housing 11 may include a first inner circumferential surface 12b that supports sliding with an outer circumferential surface of the cylindrical wall 50b of the rotation gear 50. Because of this configuration, the rotation gear 50 may rotate around the axis of the screw shaft 27 in a precise manner without enlarging the main body housing 11. Accordingly, an end portion of the PEX tubing arranged in various areas may be expanded in approximately a uniform tubular shape by using the tube expansion tool 1.

As shown in FIGS. 3 and 14, the rotation gear 50 may include a guide 50e that is formed in a protruding shape or in a recessed shape in the front-rear direction. The cam member 51 may include a guide engagement portion 51d that engages the guide 50e to be movable in the front-rear direction. The guide 50e and the guide engagement portion 51d may allow the cam member 51 to move in the front-rear direction regarding the rotation gear 50 and may allow the rotation gear 50 to rotate the cam member 51 around the axis of the screw shaft 27. Because of this configuration, any rotation power loss that is transmitted to the cam member 51 from the rotation gear 50 may be restricted. Also, movement of the cam member 51 in the up-down direction and in the left-right direction may be restricted. Accordingly, when the plurality of jaws 4 rotates around the axis of the screw shaft 27, energy loss may be reduced. Furthermore, for example, when the coil spring 52 having a natural length does not bias the cam member 51, the rotation gear 50 may rotate integrally with the cam member 51. Thus, a fatigue fracture of the coil spring 52 can be restricted.

As shown in FIGS. 7 and 9, the coil spring 52 may be inserted between the rotation gear 50 and the cam member 51. The coil spring 52, the rotation gear 50, and the cam member 51 may integrally rotate around the axis of the screw shaft 27. Because of this configuration, when the rotation gear 50 and the cam member 51 rotate around the axis of the screw shaft 27, the coil spring 52 may be prevented from storing compression energy or expansion energy. Accordingly, the coil spring 52 can be restricted from generating energy loss. Also, a repetition of compression or expansion of the coil spring 52 can be reduced, thereby restricting a possible fatigue fracture of the coil spring 52.

As shown in FIG. 14, the cam engagement portions 51e formed in a protruding shape in the front-rear direction may be formed on the front surface 51f of the cam member 51. The jaw engagement portion 4b that is formed in a recessed shape in the front-rear direction and that engages one of the cam engagement portions 51e may be formed on the rear surface of each of the plurality of jaws 4. The cam member 51 may be movable rearward over a length of the cam engagement portion 51e in the front-rear direction against the biasing force of the coil spring 52. Because of this configuration, even in a state where the front surface 51f of the cam member 51 interferes with the rear surface of each of the plurality of jaws 4, in more detail, in a state where a most projected part of the cam engagement portions 51e contacts a most projected part of the projections 4d, engagement of the cam engagement portions 51e with the jaw engagement portions 4b may return to a normal state by moving the cam member 51 rearward. Accordingly, the cap 2 can be positioned at the rearmost position.

As shown in FIGS. 7 and 9, the rotation gear 50 may include a spring receiving portion (stopper) 50d that contacts the rear-end of the wedge 3 to prevent the wedge 3 from excessively moving rearward. Because of this configuration, strength of the stopper 50 can be obtained by forming the stopper 50d in the rotation gear 50. Accordingly, a heavy load can be prevented from applying to other components such as, for example, the feed screw mechanism 25 that engages the screw shaft 27 in the front-rear direction.

As shown in FIGS. 7 and 9, the rotation gear 50 may include the cylindrical-shaped cylindrical wall 50b into which the wedge 3 is inserted. The stopper 50d may extend radially inward from the cylindrical wall 50b. The coil spring 52 may be arranged on an inner side of the rotation gear 50. The rear portion of the coil spring 52 may contact the spring receiving portion (stopper) 50d. Because of this configuration, the coil spring 52 may generate a biasing force that biases the cam member 51 forward. The spring receiving portion 50d may serve as a stopper that restricts rearward movement of both the wedge 3 and the supporting portion of the coil spring 52, thereby making the rotation gear 50 compact. Also, the coil spring 52 may be arranged inside of the rotation gear 50, thereby housing the coil spring 52 in a compact manner. Accordingly, the main body housing 11 can be formed compactly.

As shown in FIGS. 7 and 9, the plurality of balls 27b may be placed in the engagement portions between the screw shaft 27 and the female screw portion 26. Because of this configuration, a transmission efficiency of rotation power from the female screw member 26 to the screw shaft 27 can be improved by the plurality of balls 27b placed in the engagement portions. Accordingly, rotation power of the female screw member 26 can be efficiently transmitted to a movement of the screw shaft 27 in the front-rear direction.

The embodiments discussed above may be modified in various ways. In the above-exemplified embodiment, the tube expansion tool 1 may include six jaws 4. Instead, the tube expansion tool 1 may include less than six jaws 4 or more than six jaws 4.

In the exemplified embodiment, the plurality of jaws 4 may rotate counterclockwise when viewed from the front in the jaw rotation mechanism 30. Instead, the jaw rotation mechanism 30 may be configured such that the plurality of jaws 4 rotate clockwise viewed from the front. In this case, a rotation direction of the front shaft 32 in which the one-way clutch 42 transmits rotation power of the front shaft 32 to the driving side gear 43 may be the first rotation direction R1 (refer to FIG. 5).

In the exemplified embodiment, the feed screw mechanism 25 may include the plurality of balls 27b placed between the female screws 27a of the screw shaft 27 and the female screw 26b of the female screw member 26. Instead, for example, the feed screw mechanism 25 may be such that male screw 27a directly engages the female screw 26b without placing the plurality of balls.

In the exemplified embodiment, both of the screw shafts 27 and the wedge 3 may be inserted into the cylindrical wall 50b. Instead, either one of the screw shaft 27 and the wedge 3 (for example, only a screw shaft 27) may be inserted into the cylindrical wall 50b. In the exemplified embodiment, both of the screw shafts 27 and the wedge 3 may be inserted into the cylindrical portion 51a of the cam member 51. Instead, either one of the screw shaft 27 and the wedge 3 (for example only the wedge 3) may be inserted into the cylindrical portion 51a of the cam member 51.

In the exemplified embodiment, the guide 50e in a projection shape may be formed in the rotation gear 50 and the guide engagement portion 51d in a recessed shape may be formed in the cam member 51. Instead, the guide 50e and the guide engagement portion 51d may be formed in a recessed shape and in a projection shape, respectively. Similarly, the cam engagement portion 51e and the jaw engagement portion 4b may be inversely formed in a recess-projection.

In the exemplified embodiment, the coil spring 52 may be exemplified as a biasing member that biases the cam member 51 forward. Instead, for example, a tubular-shaped rubber member may be used. In the exemplified embodiment, the coil spring 52 may be placed on an inner circumferential side of the cylindrical wall 50b of the rotation gear 50. Instead, the coil spring 52 may be placed on an outer circumferential side of the cylindrical wall 50b of the rotation gear 50.

In the exemplified embodiment, the tube expansion tool 1 may expand an end portion of a synthetic resin-made fluid pipe. Instead, an end portion of a copper-made fluid pipe (copper tube) can be expanded in order for the fluid pipe to be coupled to a pipe fitting by use of the exemplified tube expansion tool 1.

The tube expansion tool 1 in the above embodiment may be one example of a tube expansion tool according to one aspect of the present disclosure. The electric motor 20 in the embodiment may be one example of a motor according to one aspect of the present disclosure. The female screw member 26 in the embodiment may be one example of a female screw member according to one aspect of the present disclosure. The detector 29 in the embodiment may be one example of a detector according to one aspect of the present disclosure. The regenerative braking in the embodiment may be one example of braking according to one aspect of the present disclosure. The controller 9 in the embodiment may be one example of a controller according to one aspect of the present disclosure.

The stator 20b in the embodiment may be one example of a stator according to one aspect of the present disclosure. The rotor 20c in the embodiment may be one example of a rotor according to one aspect of the present disclosure.

The magnet 28d in the embodiment may be one example of a first magnet according to one aspect of the present disclosure. The front-end sensor 29b in the embodiment may be one example of a first hall element according to one aspect of the present disclosure. The tool main body 10 in the embodiment may be one example of a tool main body according to one aspect of the present disclosure.

The motor sensor 20d in the embodiment may be one example of a motor sensor according to one aspect of the present disclosure.

The magnet 20h in the embodiment may be one example of a second magnet according to one aspect of the present disclosure. The hall element 20g in the embodiment may be one example of a second hall element according to one aspect of the present disclosure.

The planetary gear reduction mechanism 22, the gear shaft 23, the idle gear 24, and the female screw member 26 in the embodiment may be one example of a transmission mechanism according to one aspect of the present disclosure. The pressure sensor 15c in the embodiment may be one example of a sensor according to one aspect of the present disclosure.

The ball 27 in the embodiment may be one example of a ball according to one aspect of the present disclosure.

What is claimed is:

1. A tube expansion tool for expanding an end portion of a fluid pipe, comprising:
a female screw configured to be rotated by a motor;
a screw shaft configured to engage the female screw to move the screw shaft in a front-rear direction;
a plurality of jaws configured to expand in a radial direction;
a wedge positioned at a front-end of the screw shaft to insert into between the plurality of jaws, wherein the wedge is configured for expanding the end portion of the fluid pipe via the plurality of jaws;
a detector configured to detect that the screw shaft has reached a front-end position; and
a controller configured to perform a braking operation of the motor upon the controller determining that the screw shaft has reached the front-end position based on a signal from the detector, and to rotate the motor in a reverse direction to move the screw shaft rearward upon the controller detecting that the screw shaft has stopped.

2. The tube expansion tool according to claim 1, wherein after performing the braking operation, the controller rotates the motor in the reverse direction upon detecting a stopping or rearward movement of the screw shaft.

3. The tube expansion tool according to claim 2, wherein after a predetermined period-of-time has passed upon the screw shaft reached the front-end position or the controller started to perform the braking operation, the controller rotates the motor in the reverse direction upon detecting the stopping or rearward movement of the screw shaft

4. The tube expansion tool according to claim 3, wherein the predetermined period-of-time is about between 0.1 seconds to 0.5 seconds.

5. The tube expansion tool according to claim 1, wherein:
the motor includes a stator and a rotor configured to rotate around the stator; and
the braking operation is configured such that the controller stops power supply to the motor and thereby suppresses rotor rotation by an electromotive force caused by an inertial force of the rotor.

6. The tube expansion tool according to claim 1, wherein the detector further comprises:
a first magnet attached to the screw shaft; and
a first hall element attached to a tool main body of the tube expansion tool for detecting magnetism of the first magnet.

7. The tube expansion tool according to claim 1, further comprising a first motor sensor detecting motor rotation, wherein,
the controller determines that the screw shaft has reached the front-end position based on a signal from the first motor sensor.

8. The tube expansion tool according to claim 1, further comprising a second motor sensor detecting the motor rotation, wherein,
the controller determines the stopping or rearward movement of the screw shaft based on a signal from the second motor sensor.

9. The tube expansion tool according to claims 7 and 8, wherein the first motor sensor or the second motor sensor includes a second magnet attached to the motor and a second hall element that detects magnetism of the second magnet.

10. The tube expansion tool according to claim 1 further comprises:
a transmission mechanism allocated between the motor and the screw shaft, wherein the transmission mechanism includes a gear that transmits an output of the motor; and
a sensor configured to detect a movement of at least one of the motor, the transmission mechanism, and the screw shaft, wherein the controller determines the stopping or rearward movement of the screw shaft based on a signal from the sensor.

11. The tube expansion tool according to claim 1, further comprising a number of balls placed in an engagement portion between the screw shaft and the female screw.

12. The tube expansion tool according to claim 10, wherein the sensor is a pressure sensor.

13. The tube expansion tool according to claim 1, wherein the fluid pipe is a synthetic resin-made fluid pipe.

14. The tube expansion tool according to claim 1, wherein the fluid pipe is a copper-made fluid pipe.

15. A tube expansion tool for expanding an end portion of a fluid pipe, comprising:
(1) a tool main body housed in a main body housing wherein the tool main body includes,
a female screw member configured to be rotated by a motor, wherein the motor includes a stator is arranged radially outside a motor shaft and a rotor attached to the motor shaft on an inner circumferential side of the stator,
a cylindrical-shaped screw shaft allocated in a middle of the tool main body and configured to engage the female screw to move the cylindrical-shaped screw shaft in a front-rear direction,
a conical wedge attached to a front portion of cylindrical-shaped screw shaft, a detector configured to detect that the cylindrical-shaped screw shaft has reached a front-end position,
a planetary gear reduction mechanism configured to reduce an output speed of the motor shaft, and
a feed screw mechanism having the screw shaft and the female screw member;
a ring-shaped cap attached to a front portion of the tool main body and configured for the conical wedge being positioned radially within thereof;
(2) a plurality of jaws configured to expand in a radial direction and arranged in a circumferential direction of the conical wedge;
(3) a jaw rotation mechanism configured to rotate the plurality of jaws in a circumferential direction of the conical wedge;
(4) a grip portion positioned in a lower portion of the main body housing wherein the grip extends downward and further includes a trigger-switch lever allocated at a front surface of the grip portion;
(5) a box-shaped housing portion allocated at a lower end of the grip portion and configured to extend in a front-rear direction and in a left-right direction with respect to the grip portion, wherein the box-shaped housing portion includes a controller configured to perform a braking operation of the motor upon the controller determining that the screw shaft has reached the front-end position based on a signal from the detector, and to rotate the motor in a reverse direction to move the screw shaft rearward upon the controller detecting that the cylindrical-shaped screw shaft has stopped.

16. The tube expansion tool of claim 15, further includes a battery removably attached to a battery attachment portion, wherein the battery attachment portion is positioned at a lower surface of the box-shaped housing portion.

17. The tube expansion tool of claim 15, wherein the conical wedge is configured to insert into between the plurality of jaws for expanding the end portion of the fluid pipe via the plurality of jaws.

18. The tube expansion tool of claim 15, wherein wherein the plurality of jaws radially expands by pulling the trigger-type switch lever.

19. The tube expansion tool of claim 15, wherein each of the plurality of jaws further includes a plurality of engaging recesses.

20. The tube expansion tool of claim 15, wherein the jaw rotation mechanism further includes a plurality of engaging projections configured to engage the plurality of engaging recesses for transmitting rotation power to the plurality of jaws.
